(19) United States
(12) Patent Application Publication
(10) Pub. No.: US 2021/0282986 A1
(43) Pub. Date: Sep. 16, 2021

(54) WHEELCHAIR PROPULSION ASSISTANCE DEVICES AND SYSTEMS

(71) Applicants: United States Government as Represented by the Department of Veterans Affairs, Washington, DC (US); REGENTS OF THE UNIVERSITY OF MINNESOTA, Saint Paul, MN (US)

(72) Inventors: Gary Goldish, Plymouth, MN (US); Andrew Hansen, Apple Valley, MN (US); Gregory Voss, Apple Valley, MN (US); Saeed Hashemi, Minneapolis, MN (US); William K. Durfee, Minneapolis, MN (US)

(21) Appl. No.: 17/200,339

(22) Filed: Mar. 12, 2021

Related U.S. Application Data
(60) Provisional application No. 63/131,090, filed on Dec. 28, 2020.
(60) Provisional application No. 62/989,167, filed on Mar. 13, 2020.

(51) Int. Cl. A61G 5/04

(52) U.S. Cl. CPC A61G 5/041; A61G 5/048

(57) ABSTRACT

A wheelchair can comprise a frame and a plurality of wheels rotatably attached to the frame, and a motor coupled to the frame. A power source can be configured to power the motor. A drive shaft can be coupled to the motor. A first sprocket can be coupled to the drive shaft. A second sprocket can be configured to be rotationally fixed to a wheel of the plurality of wheels. A drive belt or chain can extend between the first sprocket and the second sprocket. An input device can be configured to receive an input from an operator and, in response to receiving the input, cause the motor to rotate.

### CROSS-REFERENCE TO RELATED APPLICATIONS

The application claims priority to and the benefit of the filing dates of U.S. Provisional Patent Application No. 62/989,167, filed Mar. 13, 2020 and U.S. Provisional Patent Application No. 63/131,090, filed Dec. 28, 2020, the entirety of each of which is hereby incorporated by reference herein.

### FIELD

The application is generally related to wheelchairs and, in particular, to assemblies for assisting in propelling the wheelchair.

### BACKGROUND

Conventional assemblies for propelling manual wheelchairs have certain disadvantages. Perhaps most importantly, conventional assemblies can be prohibitively expensive and, therefore, are often not used. Most conventional assemblies are positioned between the rear wheels of the wheelchair and, therefore, interfere with a caregiver's gait as she walks behind the Wheelchair. Further, such assemblies are large and cumbersome, so they are removable to enable folding and stowing the wheelchair. However, removal and reattachment are time consuming and can cause further complications.

Other conventional propulsion assemblies frictionally engage an outer surface of a drive wheel. However, these can slip in wet conditions and are, therefore, limited in situations when they are often most needed. Further, friction drives cause wear to the drive wheel surfaces, requiring more frequent replacement of the drive wheels.

### SUMMARY

Described herein, in various aspects, is a drive assembly for a wheelchair having a frame and a plurality of wheels rotatably attached to the frame. The drive assembly can comprise a motor and a power source that is configured to power the motor. A drive shaft cats be coupled to the motor. A first sprocket can be coupled to the drive shaft. A second sprocket can be configured to be rotationally fixed to a wheel of the plurality of wheels. A drive belt or chain can extend between the first sprocket and the second sprocket. An input device can be configured to receive an input from an operator and, in response to receiving the input, one of: provide a control signal for controlling an output of the motor or create an electrical coupling that provides power to the motor.

The drive assembly can further comprise a clutch that is configured to selectively engage and disengage the motor from the wheel.

The clutch can be a centrifugal clutch.

The input device can be configured to provide a signal to the clutch in response to receiving the input from the operator. The clutch can be configured to engage upon receiving the signal from the input device.

The input device can comprise a variable speed throttle.

The input device can comprise a switch. The input can be a change in state of the switch, wherein the state of the switch is one of closed and open.

The input device can comprise a lever.

The motor can have a power output that is less than 200 watts.

The power source can be a battery that is releasable by a push button detent.

The drive assembly can have a total weight of less than 3.0 kg.

A wheelchair can comprise a frame and a plurality of wheels rotatably attached to the frame. A motor can be coupled to the frame. A power source that is configured to power the motor. A drive shaft can be coupled to the motor. A first sprocket can be coupled to the drive shaft. A second sprocket can be configured to be rotationally fixed to a wheel of the plurality of wheels. A drive belt or chain can extend between the first sprocket and the second sprocket. An input device can be configured to receive an input from an operator and, in response to receiving the input, one of: provide a control signal for controlling an output of the motor or create an electrical coupling that provides power to the motor.

The frame of the wheelchair can be collapsible relative to an axis of rotation of the wheel of the plurality of wheels.

The motor can be offset from a plane that is perpendicular to the axis of rotation of the wheel and that bisects the wheelchair.

The motor can be offset from the plane by at least 6 inches.

The wheel of the plurality of wheels can have a rotational axis. The wheelchair can further comprise: a push rim having a rotational axis that is offset from the rotational axis of the wheel of the plurality of wheels. A push rim sprocket can be fixedly coupled to the push rim. The belt or chain can engage the push rim sprocket.

The frame can comprise a plurality of frame members and at least one brace connected to at least one of the frame members, wherein the at least one brace is configured to release the at least one of the frame members to collapse the wheelchair relative to a collapsible axis.

The drive assembly can be limited to causing a top speed of the wheelchair of 1.5 meters per second.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a diagram illustrating an example wheelchair.

FIG. 2 is a diagram illustrating an example wheelchair transfer with a transfer board.

FIGS. 3A and 3B are diagrams illustrating an example wheelchair transfer without a transfer board.

FIGS. 4A-4D are diagrams illustrating an example wheelchair with a push rim capable of being rotated backward and out of the way for transfers according to a first implementation of the present application.

FIGS. 5A-5D are diagrams illustrating an example wheelchair with a push rim capable of being removed and placed out of the way for transfers according to a second implementation of the present application.

FIG. 6 is a top view illustrating an example transfer of a patient from a bed to a wheelchair according to an embodiment of the invention.

FIGS. 7A-7B are diagrams illustrating an example wheelchair with a push rim capable of being translated backward and out of the way for transfers according to a third implementation of the present application.

FIG. 8 is a diagram illustrating a user's range of motion laid over a diagram of an example wheelchair.

FIG. 9 is a diagram illustrating a user's range of motion laid over a diagram of a wheelchair according to an implementation of the present application.

FIGS. 10A-10C are diagrams illustrating placement of a push rim at different positions along a wheelchair according to an implementation of the present application.

FIGS. 11A-11B are front view diagrams illustrating a collapsible wheelchair frame.

FIG. 12 is an expanded view diagram illustrating an example drive wheel and first brace according to an implementation of the present application.

FIG. 13 is a front view diagram illustrating an example drive wheel connected to first brace of a wheelchair frame according to an implementation of the present application.

FIG. 14 is an expanded view diagram illustrating an example push rim and second brace according to an implementation of the present application.

FIG. 15 is a front view diagram illustrating an example push rim and second brace connected to a wheelchair frame according to an implementation of the present application.

FIG. 16 is an expanded view diagram illustrating an example drive wheel and first brace combined with an example push rim and second brace according to an implementation of the present application.

FIG. 17 is a front view diagram illustrating an example drive wheel and first brace combined with an example push rim and second brace and connected to a wheelchair frame according to an implementation of the present application.

FIG. 18 is an expanded view diagram illustrating an example push rim and drive chain guard and second brace according to an implementation of the present application.

FIG. 19 a front view diagram illustrating an example push rim and drive chain guard. and second brace connected to a wheelchair frame according to an implementation of the present application.

FIG. 20 is a front view diagram illustrating an example drive wheel and first brace combined with an example push rim and drive chain guard and second brace and connected to a wheelchair frame according to an implementation of the present application.

FIGS. 21-23 are front view diagrams illustrating an example collapsible wheelchair having first and second braces that release the first lateral member according to an implementation of the present application.

FIGS. 24-26 are front view diagrams illustrating an example collapsible wheelchair having first and second braces that release the second lateral member according to an implementation of the present application.

FIGS. 27-29 are front view diagrams illustrating an example collapsible wheelchair having first and second braces that release the first and second lateral members according to an implementation of the present application.

FIG. 30 is a front view diagram illustrating an example collapsible wheelchair having a drive tram guard fork according to an implementation of the present application.

FIG. 31 is a front view diagram illustrating an example collapsible wheelchair having a drive train guard fork and a single brace according to an implementation of the present application.

FIGS. 32-33 are front view diagrams illustrating an example collapsible wheelchair having first and second braces that release the first and second lateral members according to the implementation of FIG. 30.

FIG. 34 is a front view diagram illustrating an example collapsible wheelchair having a removable push rim according to an implementation of the present application.

FIG. 35 is an expanded side view diagram illustrating an example drive train orientation with respect to the first brace and the second brace and first and second axes of rotation according to an implementation of the present application.

FIG. 36 is a side view diagram illustrating an example drive train guard orientation with respect to first and second lateral frame members according to an implementation of the present application.

FIG. 37 is a side view diagram illustrating an example drive train guard orientation with respect to first and second lateral frame members and the drive train according to an implementation of the present application.

FIG. 38 is a side view diagram illustrating an example drive train guard orientation with respect to first and second lateral frame members, the drive train, the drive wheel and the push rim according to an implementation of the present application.

FIG. 39 is a side view diagram illustrating first and second braces having variable axle position slots according to an implementation of the present application.

FIG. 40 is a side view diagram illustrating first and second braces having plural fixed axle positions according to an implementation of the present application.

FIG. 41 is a perspective view of a wheelchair having a propulsion assistance assembly in accordance with embodiments disclosed herein.

FIG. 42 is a schematic diagram of various components of the propulsion assistance assembly as in FIG. 41.

FIG. 43 is a perspective view of an input device, embodied as a thumb toggle, on a handle of a wheelchair in accordance with embodiments disclosed herein.

FIG. 44 is an inner side perspective view of a wheelchair power assistance assembly in accordance with embodiments disclosed herein.

FIG. 45 is a rear perspective view of the wheelchair power assistance assembly of FIG. 45.

FIG. 46 is an inner rear perspective view of the wheelchair power assistance assembly as in FIG. 45.

FIG. 47 is a schematic diagram illustrating the wheelchair power assistance assembly in accordance with embodiments disclosed herein.

FIG. 48 is an inner side view of a wheelchair power assistance assembly in accordance with embodiments disclosed herein.

FIG. 49 is a front perspective view of the wheelchair power assistance assembly as in FIG. 48.

FIG. 50 is a top view of the wheelchair power assistance assembly as in FIG. 48.

FIG. 51 is a schematic diagram of a rear view of a drive wheel having an integral motor and hub as disclosed herein.

FIG. 52 is a schematic diagram of the drive wheels and drive assemblies of an exemplary Wheelchair in a collapsed configuration.

### DETAILED DESCRIPTION

The present invention now will be described more fully hereinafter with reference to the accompanying drawings, in which some, but not all embodiments of the invention are shown. Indeed, this invention may be embodied in many different. forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one Skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a wheel” can refer to one or more of such wheels, and so forth.

All technical and scientific terms used herein have the same meaning as commonly understood to one of ordinary skill in the art to which this invention belongs unless clearly indicated, otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more off.” For example, “at least one of A, B and C” explicitly includes only A, only B, only C. and combinations of each.

Ranges can be expressed herein as from “about” one particular value, md/or to “about” another particular value. When such a range is expressed, another aspect includes from the one particular value and/or to the other particular value. Similarly, when values are expressed as approximations, by use of the antecedent “about,” it will be understood that the particular value forms another aspect. It Will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects.

The word “or” as used herein means any one member of a particular list and also includes any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. Thin holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing. these specific details. Indeed, the apparatus, system, and associated methods can be placed into practice by modifying the illustrated apparatus, system, and associated methods and can be used in conjunction with any other apparatus and techniques conventionally used in the industry.

### Wheelchair Propulsion Assembly

Wheelchair users and caregivers who push wheelchairs can benefit from propulsion assistance. For example, it can be beneficial to have a motor that propels the wheelchair to relieve some or all of the manual effort that a user or caregiver would have to provide.

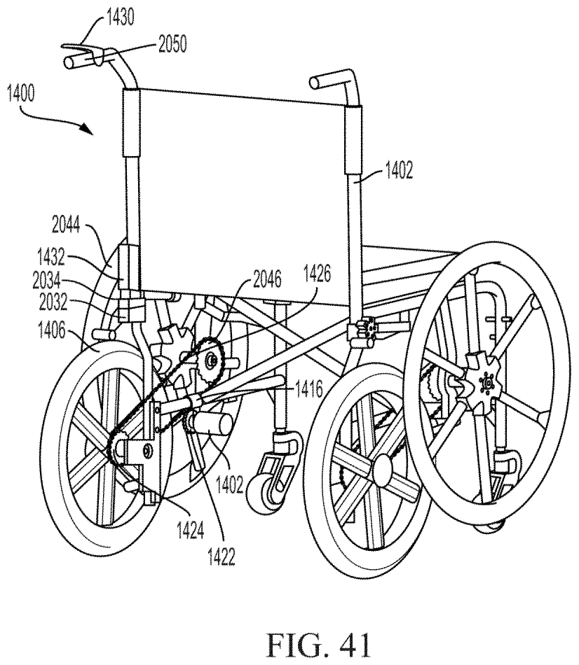

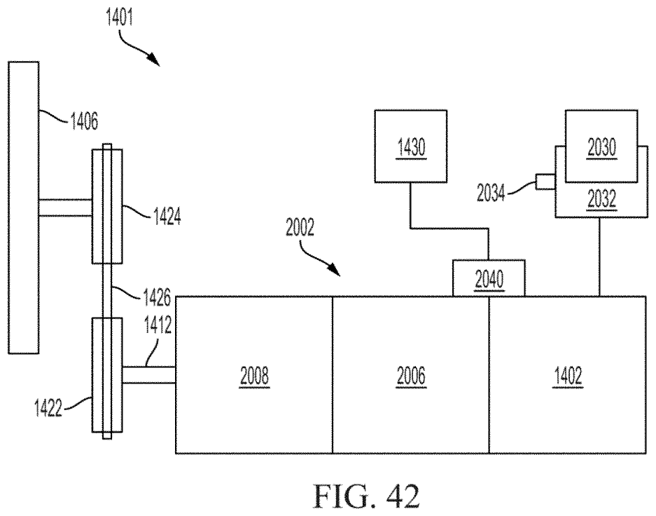

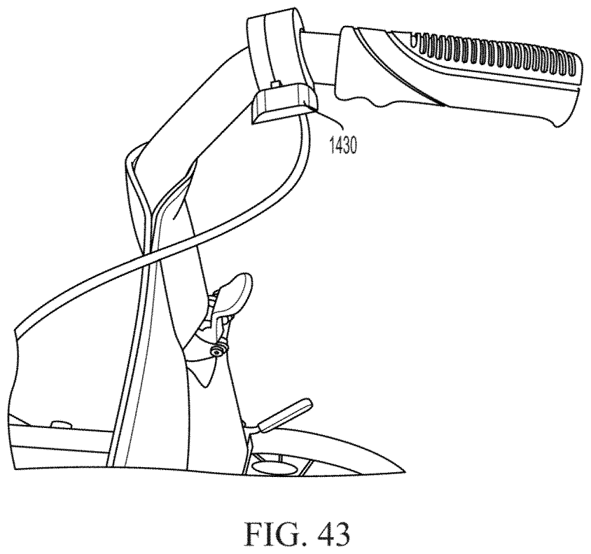

Referring to FIGS. 41 and 42, a wheelchair 1400 can comprise a frame 1404. The frame can define, or couple to, a seat and a backrest for comfortably supporting the user in a seated position. The wheelchair can further comprise a foot support for the user to rest her feet. The frame can optionally define handles 2050 that a caretaker can grip to push and pull the wheelchair from behind. The wheelchair 1400 can comprise drive wheels 1406, often positioned at the rear of the wheelchair, that are rotatably coupled to the frame 1402 about respective rotational axes. Push rims 2044 can couple to the Wheels so that a user can push the push rims to cause the drive wheels to rotate. Swivel casters, often positioned in front of the drive wheels, can enable the wheelchair to pivot. In some aspects, the wheelchair 1400 can optionally be configured in accordance with, or include components or features of, the embodiments disclosed herein. In further aspects, the wheelchair 1400 can be any type of wheelchair that can accommodate a propulsion assembly in accordance with embodiments disclosed herein.

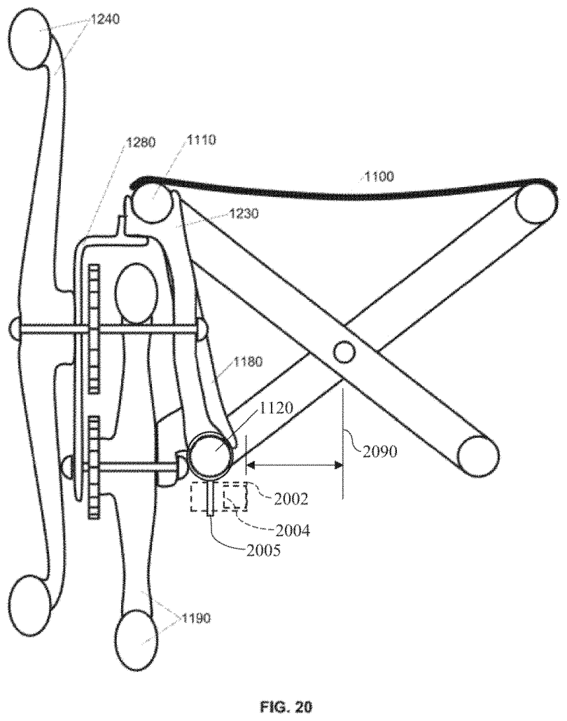

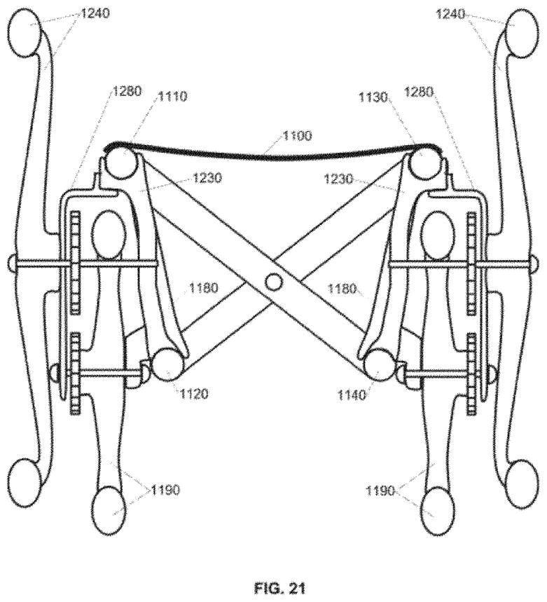

In some aspects, a propulsion (drive) assembly 1401 can comprise a drive unit 2002 including a motor 1402. The drive unit 2002 can couple to the frame 1402. In some aspects, the drive unit 2002 can couple to the frame 1402 via an angle bracket 1416. The angle bracket 1416 can comprise a first portion that extends around a member of the frame (e.g., the lateral frame member 1120, shown also in FIG. 20) and a second portion that extends vertically downward from the frame to provide a mounting surface against which a portion of the drive unit can fixedly (nonrotatably) attach. In further optional aspects, the drive unit 2002 can be disposed within the frame. For example, it is contemplated that the frame can comprise hollow, round tubing, and a portion of the hollow round tubing can receive at least a portion of the drive unit 2002. in some aspects, the motor and'or drive unit can be housed entirely within a portion of the frame. In optional aspects, the drive unit 2002 can further comprise a gearbox 2006 and/or a clutch 2008. A drive shaft 1412 can couple to the drive unit 2002 so that rotation of the motor 1402 can impart rotation of the drive shaft 1412, A motor sprocket 1426 can, in turn, couple to the drive shaft 1412. A drive wheel sprocket 1424 can be fixedly coupled to a drive wheel 1406 so that rotation of the drive wheel sprocket 1424 causes rotation of the drive wheel 1406. As used herein, “fixedly coupled” should be understood to describe a coupling in which a first component is coupled to a second component so that rotation of the first component by an angular displacement causes corresponding rotation of the second component by the same angular displacement. As those skilled in the art can appreciate, components can be fixedly coupled together by known means such as spline or keyed couplings. In further optional aspects, the sprockets can attach via a square taper, as is common in various applications, such as, for example, bicycles, and is not described in detail herein. in various aspects, the drive wheel sprocket 1424 can couple to the drive wheel, and the drive wheel can be rotatable about its axle (e.g., via a bearing disposed between the drive wheel and the axle). In further aspects, and as further disclosed herein, the drive wheel can fixedly couple to its axle, and the drive wheel sprocket 1424 can fixedly couple to the drive wheel axle to thereby fixedly couple to the drive wheel The motor sprocket 1426 can engage a belt or chain 1426 that extends between and engages the motor sprocket 1426 and the drive wheel sprocket 1424. In this way, rotation of the motor can cause the motor sprocket 1426 to rotate, thereby driving the drive wheel sprocket 1424. In further optional aspects, in embodiments that comprise push rims 2044 that have rotational axes that are offset from the rotational axes of the drive wheels, the belt or chain 1426 can further engage a push rim sprocket 2046 that is fixedly coupled to a respective push rim 2044. For example, a respective belt or chain 1426 can extend about and between a push rim sprocket 2046 and a drive wheel sprocket 1424 on each side of the wheelchair, and the motor sprocket 1426 can engage one of the belt or chains 1426. In some optional aspects, the motor sprocket 1426 can engage an outer side of the belt or chain 1426. Optionally, the motor sprocket 1426 can serve as a tensioner to the belt or chain. Optionally, the motor sprocket 1426, when not providing power to the drive wheels, can serve as an idler and rotate freely.

In some optional aspects, it is contemplated that the total power of the motor can be less than 250 watts, or less than 200 watts, or between 90 and 120 watts. In further aspects, it is contemplated that the maximum propulsion speed can be no greater than 1.5 meters per second or no greater than 1.7 meters per second. in some optional aspects, the propulsion assembly for each drive wheel can weigh about 650 grams (e.g., about 140 grams for the motor. about 360 grams for the sprockets, 80 grams for the bracket, and 70 grams for the belt or chain). Thus, for a drive system comprising a motor coupled to each wheel, the propulsion assembly can weigh about 1.3 kg. The battery and control system can weigh about 1.4 kg or less, less than 1 kg, or about 0.7 kg or less. The drive system can be configured to propel the wheelchair at about 1 m/s or at least 1 m/s.

An input device 1430 can communicatively couple to the drive unit 2002 to provide a control signal to control the motor. In some optional aspects, the input device can be positioned on a handle 2050 of the frame 1402 of the wheelchair 1400. In this way, a caretaker can actuate the input device while pushing the wheelchair with the handles. In further optional aspects, the input device can be positioned so that the individual in the wheelchair can actuate it. For example, the input device can optionally be secured to or positioned near the seat or, for an embodiment comprising armrests, on an armrest.

In some aspects, the input device 1430 can comprise a lever. The lever can optionally actuate a switch. For example, when the lever is pressed, the switch can close to complete a circuit. The completed circuit can cause the motor to rotate and, thus, drive the wheels. Thus, in some optional aspects, the control signal can be power provided to the motor. In further aspects, the input device 1430 can be a variable throttle. For example, the throttle can comprise a lever that is spring-biased toward a first position and an angle sensor (e.g., a potentiometer or Hall Effect sensor). Depressing the lever by an increasing angular amount from the first position can cause a changing (e.g., increasing) throttle output (e.g., a 0-5 V control signal based on the angle of the sensor). The input device can provide the throttle output to the motor. The motor can be configured to vary its power output based on the signal received from the throttle.

In further aspects, the input device 1430 can be a momentary button. In other aspects, the input device can comprise a rotatable collar and an angle sensor that is configured to measure the angular position of the rotatable collar, wherein an increasing angular displacement of the rotatable collar from a first position corresponds to an increasing throttle output. In further aspects, the input device can be a pivotable thumb-actuated throttle. Optionally, in still further aspects, the input device can be a joystick. It is contemplated that, in some optional aspects, the wheelchair can comprise two drive units (one coupled to each drive wheel via a respective pair of sprockets and a respective belt Or chain extending between the pair of sprockets), and the joystick can control independent movement of each of the drive units.

In some aspects, the input device can control the power to the motor. For example, a momentary switch can couple and decouple the motor with the power source. For a brushed motor, the input device can control the input voltage, thereby controlling directly the motor power. For a brushless motor, the input device can be in communication with a motor controller 2040 (FIG. 42) and can provide a control signal to the motor controller. In sonic aspects, the motor controller can comprise a proportional-integral-derivative (PID) control algorithm. For example, the input device can provide a signal corresponding with a target speed, and the motor controller can use the ND control algorithm to match the target speed. In this way, the motor can comprise a speed control device.

In some aspects, an electronic circuit can detect a locked rotor (so that the motor cannot turn). For example, the electronic circuit can detect an absence of rotation in response to a threshold current that should cause the motor to rotate. The electronic circuit can provide an interrupt that stops delivery of current to the motor, thereby preventing damage to the motor. A current limiter can further inhibit damage to the batteries.

A power source, such as, for example, a battery pack (or other power source) 1432, can be configured to power the drive unit 2002 (and, optionally, the input device 1430). The battery pack 1432 can be electrically coupled to the drive unit 2002. The battery pack 1432 can optionally be selectively removable and replaceable. For example, the battery pack can be received within a receptacle 2032 that provides electrical communication to the drive unit 2002. The receptacle 2032 can comprise a quick-release 2034 that can enable rapid replacement of battery pack 1432 (e.g., for replacing a depleted battery pack with a charged battery pack). For example, the receptacle 2032 can comprise a decent that is actuatable by a push button to release the battery pack.

In some aspects, the battery pack 1432 can be charged while received within the receptacle 2032. For example, one of the battery pack 1432 and the receptacle 2032 can comprise a charging port.

The clutch 2008 can selectively engage and disengage the motor from the wheels. In this way, the motor can be configured to propel the wheelchair forward, but when the motor is not driving the wheelchair, the motor can be disengaged so as not to encumber manual. movement of the wheelchair. By enabling unencumbered manual propulsion, battery power can be conserved, thereby extending the life of the battery. The clutch 2008 can optionally be engaged by movement of the motor. For example, the clutch 2008 can be a centrifugal clutch. In further aspects, the clutch can be disengaged via an electric signal. For example, the clutch 2008 can optionally be activated when the throttle is engaged to drive the motor. Likewise, the clutch 2008 can be disengaged when the throttle is disengaged. For example, for a variable throttle, when the throttle output of the clutch reaches a threshold, the clutch can engage. Thus, in some aspects, a controller 2040 can receive the signal from the input device 1430, compare the signal to a threshold, and cause the clutch 2008 to engage in response to the signal achieving or surpassing the threshold. It is contemplated that a throttle-controlled clutch can be preferable to minimize abrupt engagement and disengagement that is unpleasant to the user.

In some aspects, the propulsion assembly 1401 can be configured to supplement manual propulsion, such as, fir example, a caregiver pushing the wheelchair. Accordingly, the motor can have a select size that enables portability and reduces cost. For example, the motor can have a maximum power output that is less than 200 watts. In further aspects, the motor can have a maximum power of between 90 and 120 watts. The motor can be geared to provide low-end torque that can be beneficial in effecting movement of the wheelchair from a stop (as opposed to gearing Liar maximizing wheelchair velocity). Because the motor can be small relative to conventional wheelchair propulsion mechanisms, the battery size can similarly be minimized to reduce weight and cost. Thus, the combined weight of the propulsion assembly 1401, including (or, optionally, consisting of) the drive unit 2002, the input device 1430, the battery 1432 and hatter receptacle 2032, the drive shaft 1412, the motor sprocket 1426, the belt or chain 1426, and the drive wheel sprocket 1424, can be less than 3.0 kg. In further aspects, said combined weight can be less than 2.0 kg. This can be less than half of the weight of conventional systems that weigh about 6 kg or more.

Referring also to FIG. 20, the motor 1402 and, optionally, the entire drive unit 2002 can be positioned on one side of the wheelchair. That is, the motor 1402 and/or drive unit 2002 can be offset from a central plane that bisects the wheelchair and is perpendicular to the axis of rotation of the drive wheels. In this way, unlike conventional propulsion mechanisms that are positioned centrally between the rear wheels and obstruct the natural gait of a caregiver pushing the wheelchair, the motor 1402 and drive unit 2002 can be spaced from the central plane 2090 by at least six inches or at least five inches. In further aspects, the motor and/or drive unit can be mounted vertically so that the motor is spaced from the central plane by about nine inches.

As disclosed herein, the wheelchair 1400 can be configured to collapse. For example, the drive unit 2002 can optionally have a length under or about 3 inches and can be positioned on the wheelchair to enable full collapse. The exemplary wheelchairs shown herein, as well as most conventional folding wheelchairs, utilize a scissor folding mechanism. The drive unit 2002 can mount to one frame side frame member (e.g., the brace 1180 or one of the lateral frame members 1110, 1120). In this way, as the wheelchair folds, the drive unit 2002 can move toward the center. Accordingly, the propulsion assembly can remain attached to the wheelchair when the wheelchair is folded and stored, thereby eliminating the need to remove and reattach the propulsion assembly every time the wheelchair is collapsed. Thus, the propulsion assembly 1401 can optionally be permanently mounted to the wheelchair, thereby eliminating the need to remove for collapsing and reattach after unfolding the wheelchair. This can contrast with conventional wheelchair assist drives that couple to scissor folding members (corresponding to cross frame members 1150, 1160 of the illustrated embodiments) so that the wheelchair assist drives have to be removed in order to fold the wheelchair.

By coupling the motor to one of the drive wheels 1406 instead of positioning an additional motor-driven wheel between and rearward of the drive wheels as in conventional wheelchair assist drive systems, drag and slippage between the three wheels (two drive wheels and additional motor-driven wheel) can be eliminated, thereby maximizing steerability over conventional wheelchair assist drive systems. Thus, by eliminating the additional motor-driven wheel, the wheelchair can have the same feel as a conventional wheelchair.

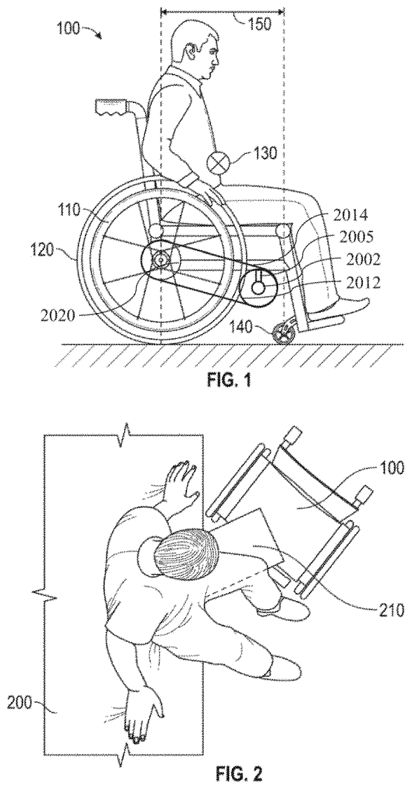

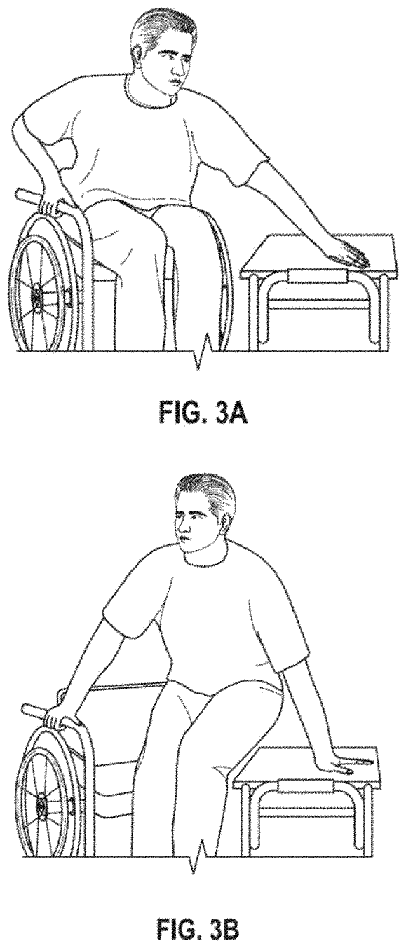

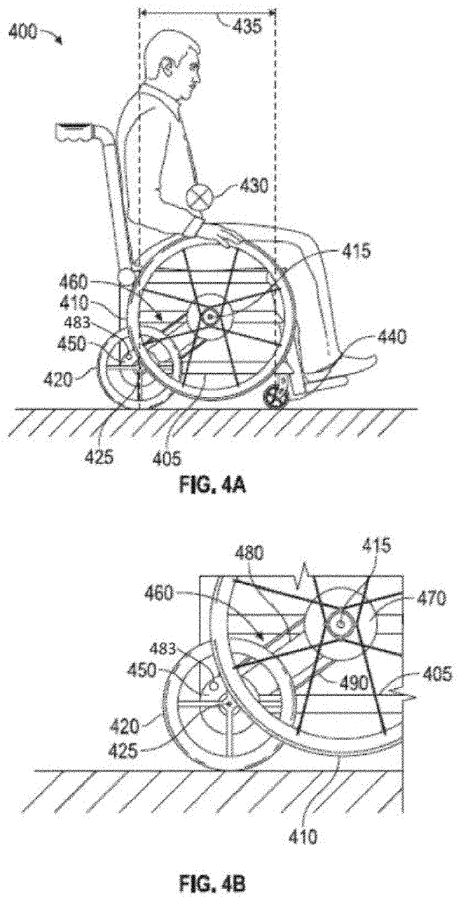

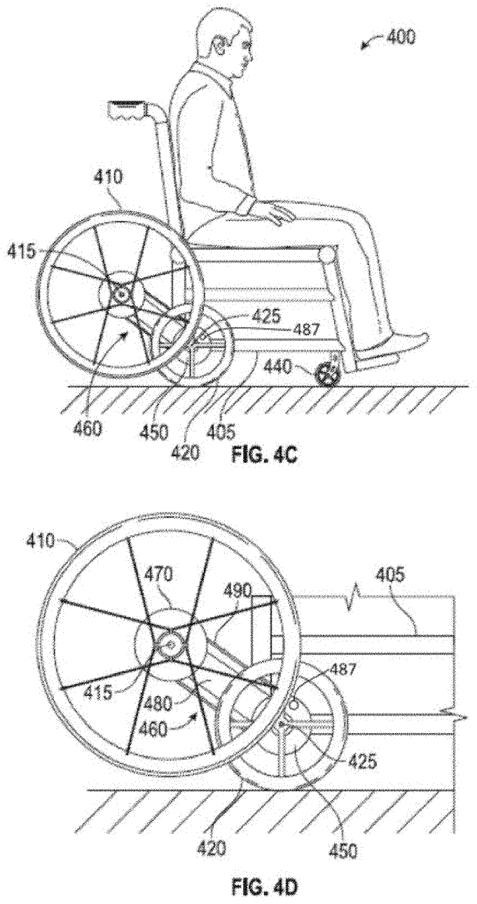

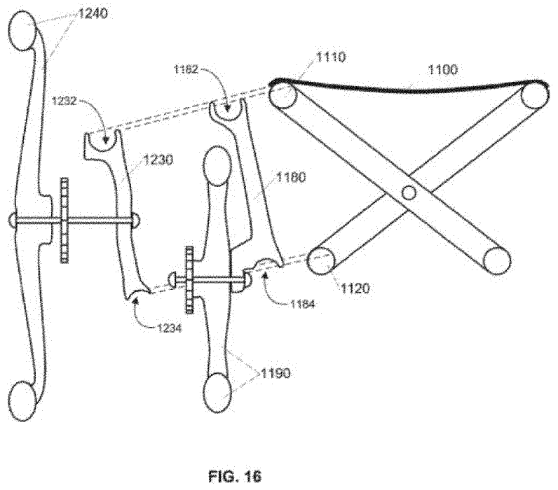

Although the advantages of the wheelchair embodiments illustrated in FIGS. 4A-42 are apparent, it is further contemplated that the propulsion assembly 1401 as illustrated in FIG. 42 can be used with various other wheelchairs, such as those illustrated in FIGS. 1-3B. For example, referring to FIGS. 1 and 42, a sprocket 1424 can be fixedly coupled to one of the drive wheels 120 so that the sprocket 1424 rotates with the coupled drive wheel 120, as shown and described with reference to FIG. 16. The drive unit 2002 (see also FIG. 41) can be coupled to the frame via a bracket 1416, and the belt or chain 1426 can extend about and between the sprocket 1424 of the drive wheel and the motor sprocket 1426.

Wheelchair with Motor-Driven Axle

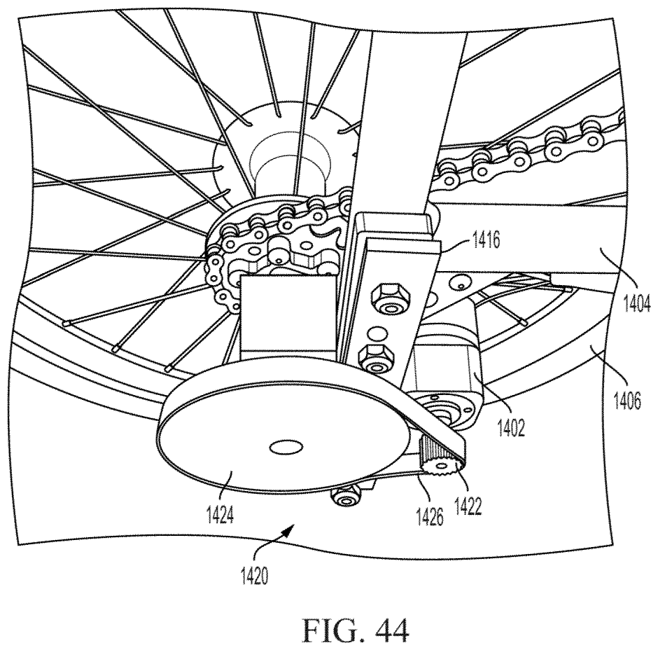

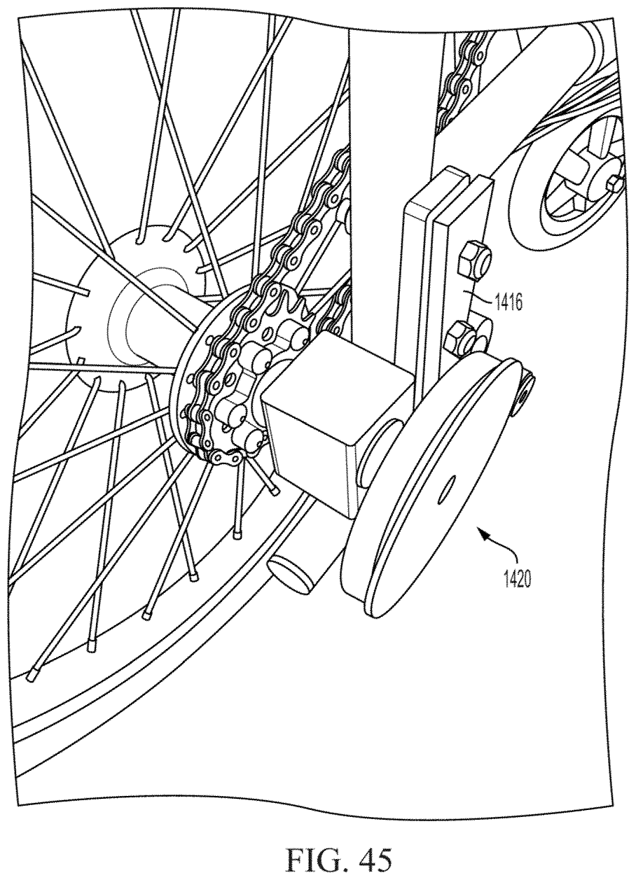

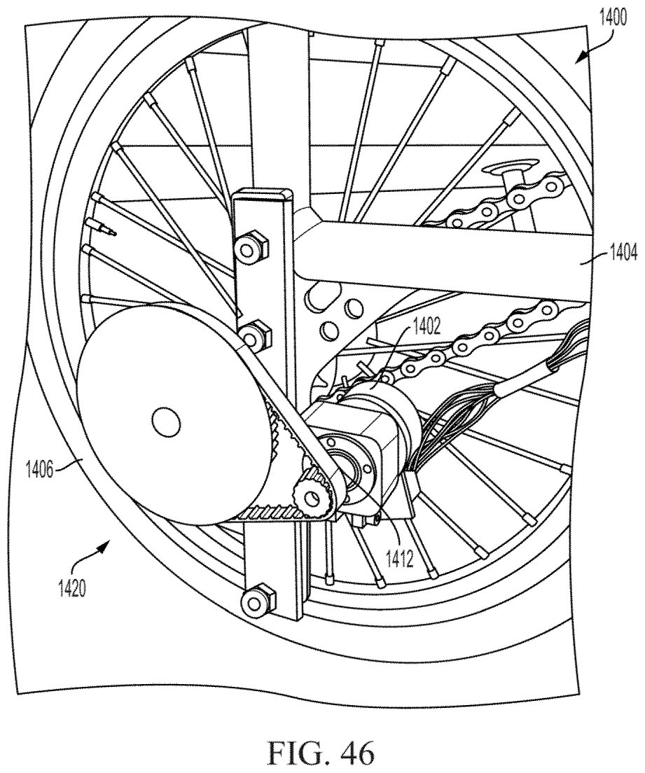

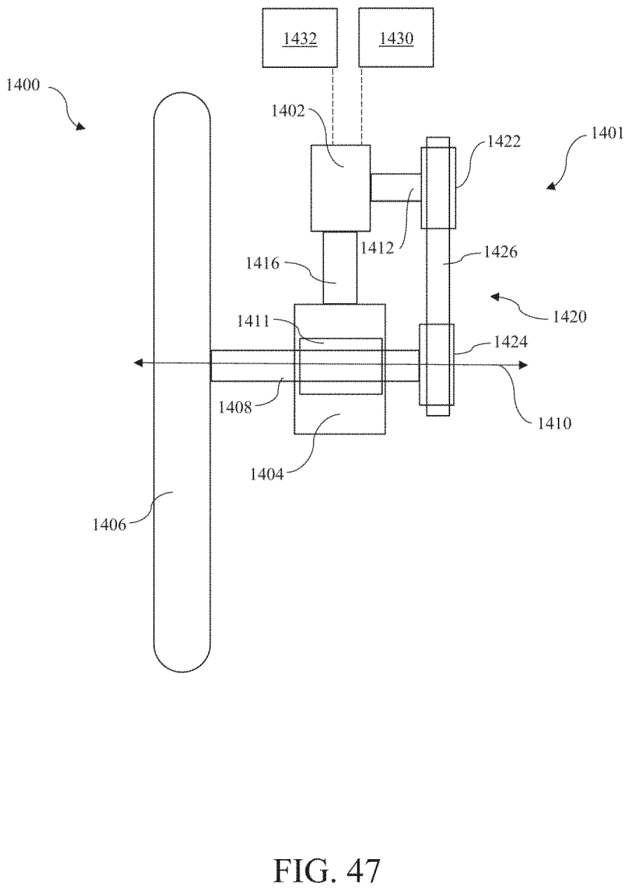

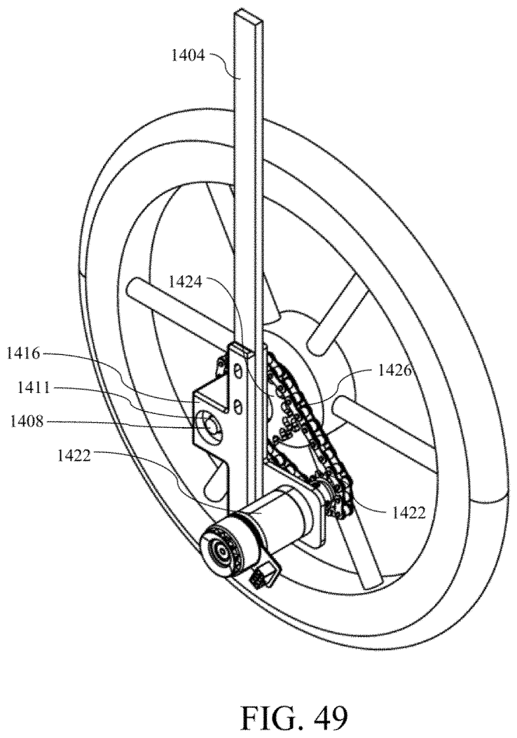

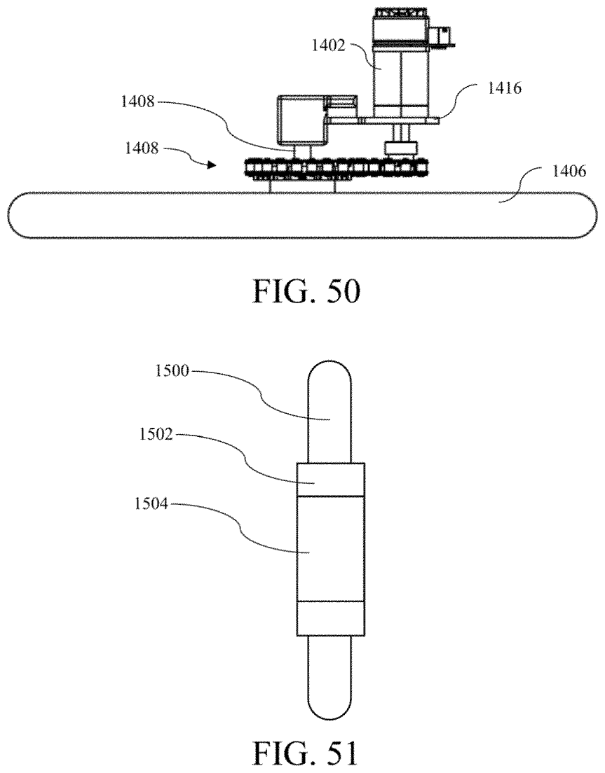

Referring to FIGS. 41-52, in various embodiments, a wheelchair 1400 can comprise a frame 1404 and a pair of drive wheels 1406 that are rotatably coupled to the frame (on opposing first and second sides of the frame). Each drive wheel 1406 can couple to the frame 1404 via a respective axle 1408 that is rotatable relative to the frame 1404 about an axis 1410. For example, the axle 1408 can be rotatably supported via a bearing 1411 to enable rotation of the axle 11408 relative to the frame 1104. The axle 1408 can be fixedly coupled to the drive wheel 1406 (e.g., via a keyway, spline, etc.) so that rotation of the axle 1408 causes corresponding rotation of the drive wheel.

A drive assembly 1401 can comprise a motor 1402 that is coupled to the frame 1404 of the wheelchair 1400. Optionally, the motor 1402 can couple to the frame 1404 via a bracket 1416. The motor 1402 can couple to, and apply torque to, a drive shaft 1412.

A transmission 1420 can couple the drive shaft 1412 to the axle 1408. Optionally, the transmission 1420 can comprise a first (motor) sprocket 1422 that is fixedly coupled to the drive shaft 1412, a second (drive wheel) sprocket 1424 that is fixedly coupled to the axle 1408, and a belt or chain 1426 that extends between the first sprocket 1422 and the second sprocket 1424. Although shown as having substantially different diameters, it is contemplated that the first sprocket 1422 and the second sprocket 1424 can have any size ratio (optionally, 1:1 or about 1:1) depending on the desired gear ratio, which can be a function of properties of the motor 1402, diameter of the drive wheel 1406, and various other factors.

An input device 1430 can be in communication with the motor 1402. The input device 1430 can be configured to receive an input from an operator and, in response to receiving the input, perform one or more of the following steps: provide a control signal for controlling an output of the first motor or create an electrical coupling that provides power to the first motor. The input device 1430 can be configured in accordance with various embodiments further described herein.

A power source 1432 (e.g., a battery) can be in communication with the motor 1402 and can be configured to power the motor.

Optionally, the drive shaft 1412 can extend inwardly from the motor 1402. That is, the motor 1402 of the drive assembly 1401 can be positioned on a first side of the wheelchair 1400, and the drive shaft 1412 can extend from the motor 1402 toward the opposing second side of the wheelchair 1400 (i.e., toward the central plane 2090, as in FIG. 20). It is contemplated that this configuration can allow the motor 1402 to be positioned outwardly (away from the central plane 2090) to minimize interference with the space between the drive wheels 1406. In this way, the drive assembly 1401 can be positioned to minimize interference with the caregiver walking behind the wheelchair.

It is contemplated that the motor 1402 can be a back-drivable motor so that when the motor is not engaged, the caregiver can move the wheelchair without the motor 1402 applying resistance, or substantial resistance, to the force that the caregiver is applying. In further aspects, the drive assembly 1401 can comprise a clutch that is configured to decouple the motor 1402 from the axle 1408 when the motor is not applying torque to the axle.

Optionally, the wheelchair 1400 can comprise a single drive assembly 1401. further optional aspects, it is contemplated that the wheelchair 1400 can comprise at least two drive assemblies, with a respective drive assembly 1401 positioned on each side of the wheelchair 1400 for driving a respective drive wheel 1406. Accordingly, the wheelchair can comprise a first motor and a second motor that are respectively coupled to first and second drive wheels, a first and second axle, a first and second transmission, etc. It is contemplated that the respective drive assemblies 1401 can optionally be configured as mirror images of each other.

Optionally, each of the drive assemblies 1401 can comprise a separate (respective) power source 1432. Alternatively, in further aspects, each of the drive assemblies can be powered by the same (shared) power source 1432.

In various optional aspects, the input device 1430 can be a switch, as described herein. Optionally, the input device 1430 can comprise a thumb toggle or other lever. In further aspects, the input device 1430 can comprise (or be embodied as) a pair of thumb toggles (or other input devices) that can each be in communication with a respective drive assembly 1401. In this way, the respective drive assemblies 1401 can be independently actuated to assist with turning. In further aspects, the input device 1430 can comprise a joystick that can be in communication with both motors. In various aspects, it is contemplated that the input device can be any device that is configured to receive input from the user and transmit one or more corresponding outputs to one or both drive assemblies. Such input devices can comprise, but are not limited to, a keyboard, pointing device (e.g., a computer mouse, remote control), a microphone, a joystick, a haptic device, a computing device (e.g., a smartphone or tablet), a scanner, a touchscreen display, a voice recognition device, tactile input devices such as gloves, and other body coverings, motion sensor, and the like.

In various optional aspects, the wheelchair 1400 can comprise a conventional wheelchair that is retrofitted to include one or a pair of drive assemblies 1401. Thus, the coupling of the drive wheel(s) 1406 to the wheelchair can be adapted to incorporate the rotation of the axle(s) 1408. For example, the frame 1404 can be configured (optionally, adapted or modified) to receive and support the bearings 1411 that, in turn, support the axles 1408. The bracket(s) 1416 can couple to the frame 1404 for mounting the motor(s) 1402 thereto. It is contemplated that the bracket 1416 can be adapted to cooperate with a particular wheelchair configuration/model/etc.

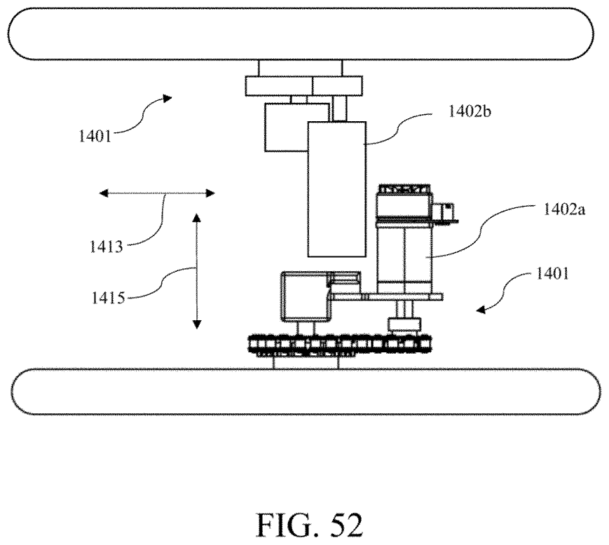

Referring also to FIG. 52, to facilitate a minimum profile in a collapsed configuration, it is contemplated that the drive assemblies 1401 can be asymmetric between both sides (e.g., left and right sides of the wheelchair). For example, a first motor 1402a can be offset from a second motor 1402b along at least one of a vertical axis or a first horizontal axis 1413 that extends between the front and rear of the wheelchair. In this way, the first and second motors 1402a,b can extend past each other along a second horizontal axis 1415 that is perpendicular to the first horizontal axis 1413. This can allow for a minimized width of the wheelchair in the collapsed configuration.

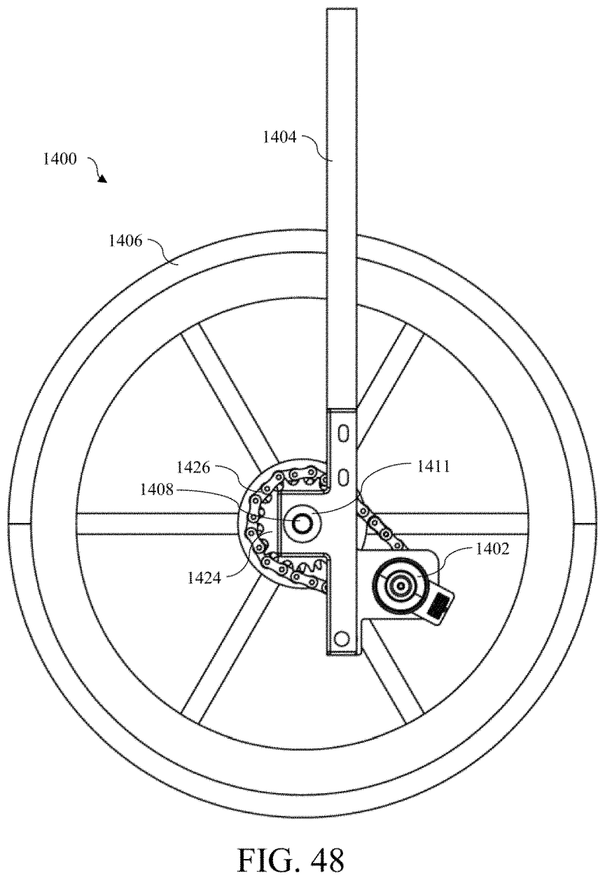

In further aspects, with reference to FIGS. 48 and 51, it is contemplated that one or both of the drive wheels 1406 can comprise an integrated motor 1502 and a huh 1504 so that the drive wheel and with the integral motor and hub collectively form a motorized drive wheel assembly 1500. That is, the motor can be configured to rotate the drive wheel about the hub. In these aspects, it is contemplated that the transmission 1420 can be omitted. In some aspects, omission of the transmission 1420 can reduce the overall weight of the wheelchair. Still further, it is contemplated that the wheelchair can be collapsible to a smaller profile than a wheelchair having a separate transmission 1420.

Thus, in some aspects, the wheelchair can comprise a frame and a plurality of drive wheels coupled to the frame, wherein one or both of the drive wheels 1406 comprise an integrated motor and hub. The wheelchair can further comprise an input device as further described herein that can control operation of the drive wheel(s) with the integrated motor and hub. It is contemplated that a conventional wheelchair can be modified to replace the conventional drive wheels with respective wheels with the integrated motor and hub. Optionally, when not needed, the motorized drive Wheel assembly 1500 can be removed and replaced with conventional drive wheels.

### Exemplary Wheelchairs

It is contemplated that the various exemplary wheelchair embodiments disclosed herein (such as those discussed below can employ drive assemblies as disclosed herein. It is contemplated that various aspects of the different embodiments can be combined to form yet further embodiments (for example, an embodiment including drive assembly features as disclosed herein). Thus, in some aspects, the wheelchair can comprise push rims that are coaxial or non-coaxial with the drive wheels. In various optional aspects, the wheelchair can be collapsible or not collapsible.

Disclosed herein, in various aspects and with reference to FIGS. 4A-4D, is an example wheelchair with a push rim capable of being rotated backward and out of the way for transfers according to a first implementation of the present application. More specifically, FIG. 4A illustrates the wheelchair with the push rim rotated forward into a propulsion position. Further, FIG. 4B illustrates an enlarged view of the push rim relocation mechanism in the propulsion position. Further, FIG. 4C illustrates the wheelchair with the push rim rotated backward into a transfer position. Further, FIG. 4D illustrates an enlarged view of the push r relocation mechanism in the transfer position.

In this implementation, the wheelchair 400 includes a frame 405, a rotatable push rim 410 connected to the frame 405 and a drive wheel 420 connected to the frame 405. The wheelchair 400 may also include caster wheels 440 located in front of the drive wheel 420. The caster wheels 440 and the drive wheels 420 collectively form the base of support 435 of the wheelchair. In order to provide a stable ride for the user, it may be preferable that caster Wheels 440 and the drive wheels be positioned such that the user's center of gravity 430 is located directly above the base of support 435, rather than in front of or behind the base of support 435.

As shown in FIGS. 4A-4D, the axis of rotation 425 of the drive wheel 420 is offset from the axis of rotation 415 of the push rim. Thus, instead of being directly coupled to each other, the push rim 410 and drive wheel 420 are connected by a transmission 460. The transmission 460 may include a drive gear hub 450 coupled to drive wheel 420, a push rim gear/hub 470 coupled to the push rim 410, and a chain or belt 490 connected to the drive gear/hub 450 and the push rim gear/hub 470.

Thus, de-coupling the fore-aft position of the push rims 410 and drive wheels 420 may allow a clinician to place the drive wheels 420 in their optimal position to provide a stable base of support 435 while still allowing the person to do “wheelies” if needed (to go over curbs and other thresholds). Also, the position of the push rims 410 can be set to promote the best positioning of the wheelchair 400 user's shoulders. A potential aspect of this more forward positioning of the push rims 410 is a reduction in shoulder pain resulting from manual propulsion of the wheelchair. In other words, de-coupling of the push rims 410 and drive wheels 420 may allow the clinician to place the push rims 420 in front of the user's center of gravity 430 as shown in FIGS. 4A-4D, potentially improving mechanical efficiency without sacrificing wheelchair stability.

Additionally, the use of the transmission 460 with the belts or chains 490 may allow the wheelchair to also incorporate into one or both of the drive gear/hub 450 and the push rim gear/hub 470 a multispeed fixed-gear hub such as the Sturmey-Archer S3X fixed-gear hub. In such implementations, the ability to switch to higher or lower speeds may allow the wheelchair user to go faster on smooth even terrain and to require less torque and forces on the shoulders to go up inclined terrain.

Additionally, in some implementations, the wheelchair 400 also includes a push rim repositioning member 480 that allows the push rim 410 to be repositioned to allow a user to transfer into and out of wheelchair 400 without having to lift himself over the push rim as shown in FIGS. 3A and 3B above. In FIGS. 4A-4D, the repositioning member 480 is a swing arm rotatably mounted to the frame 405 and configured to rotate about the axis of rotation 425 of the drive train. As shown, the push rim gear/hub 470 and push rim 410 are located at a first end of the swing arm 480 and the drive wheel gear/hub 450 is located at a second end of the swing arm 480 and the belt/chain 490 extends along the length of the swing arm. As shown in FIGS. 4A and 4B, the swing arm 480 can be rotated forward to position the push rim 410 forward of a users shoulders to allow the propulsion of the wheel chair by the user (known as the propulsion position). As shown in FIGS. 4C and 4D, the swing arm 480 can be rotated backward to position the push rim 410 behind a user's shoulders to allow the user to transfer into and out of the wheelchair.

Additionally, in some embodiment, a locking mechanism 483 may be provided to releasably hold the push rim repositioning member 480 (swing arm) in the propulsion position shown in FIGS. 4A and 4B. Further, a second locking mechanism 487 or hard stop may also be provided to releasably hold or limit the rearward rotation of the push rim repositioning member 480 (swing arm) in the transfer position shown in FIGS. 4C and 4D.

Though various aspects of this embodiment are shown in the figures and discussed above, implementations of this application are not limited to these aspects and alternative implementations are discussed below.

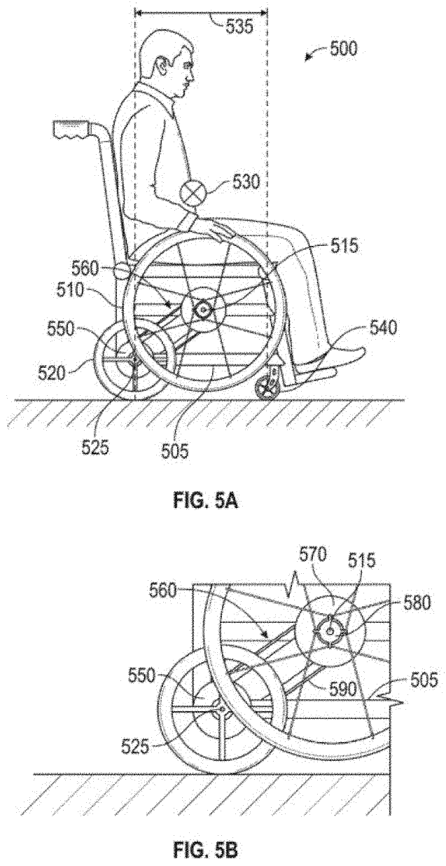

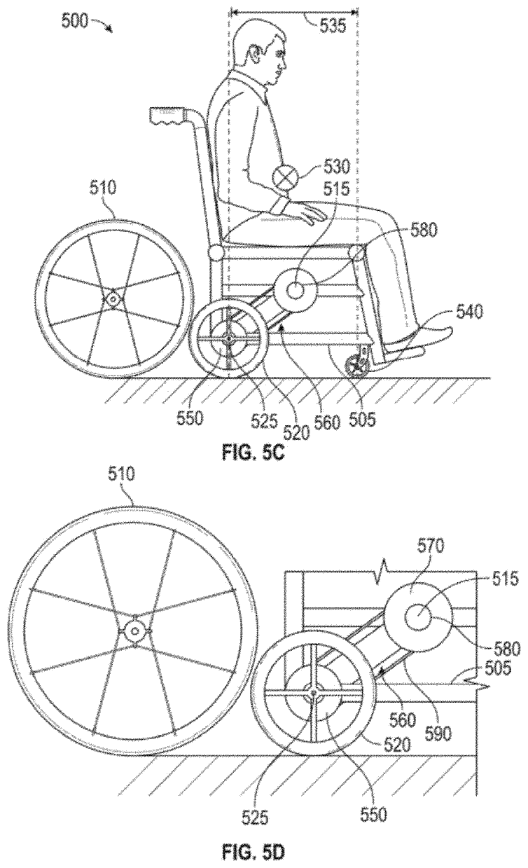

FIGS. 5A-5D are diagrams illustrating an example wheelchair with a push rim capable of being removed and placed out of the way for transfers according to a second implementation of the present application. More specifically, FIG. 5A illustrates the wheelchair with the push rim attached to the wheelchair in a propulsion position. Further, FIG. 5B illustrates an enlarged view of the push rim relocation mechanism with the push rim attached in the propulsion position. Further, FIG. 5C illustrates the wheelchair with the push rim disconnected from the wheelchair and repositioned for a transfer. Further, FIG. 5D illustrates an enlarged view of the push rim removed for a transfer.

As with the implementation discussed above, in this implementation the wheelchair 500 includes a frame 505, a rotatable push rim 510 connected to the frame 505 and a drive wheel 520 connected to the frame 505. The wheelchair 500 may also include caster wheels 540 located in front of the drive wheel 520. Again the caster wheels 540 and the drive wheels 520 collectively form the base of support 535 of the wheelchair. In order to provide a stable ride for the user, it may be preferable that caster wheels 540 and the drive wheels be positioned such that the user's center of gravity 530 is located directly above the base of support 535, rather than in front of or behind the base of support 535.

As shown in FIGS. 5A-5D, the axis of rotation 525 of the drive wheel 520 is offset from the axis of rotation 515 of the push rim 510. Thus, instead. of being directly coupled to each other, the push rim 510 and drive wheel 520 are connected by a transmission 560. The transmission 560 may include a drive gear/hub 550 coupled to drive wheel 520, a push rim gear bub 570 coupled to the push rim 510, and a chain or belt 590 connected to the drive gear/hub 550 and the push rim gear/hub 570.

Again, de-coupling the fore-aft position of the push rims 510 and drive wheels 520 may allow a clinician to place the drive wheels 520 in their optimal position to provide a stable base of support 535 while still allowing the person to do “wheelies” if needed (to go over curbs and other thresholds). Also, the position of the push rims 510 can be set to promote the best positioning of the wheelchair 500 user's shoulders. A potential aspect of this more forward positioning of the push rims 510 is a reduction in shoulder pain resulting from manual propulsion of the wheelchair. In other words, de-coupling of the push rims 510 and drive wheels 520 may allow the clinician to place the push rims 520 in front of the user's center of gravity 530 as shown in FIGS. 5A-5D, potentially improving mechanical efficiency without sacrificing wheelchair stability.

Again, the use of the transmission 560 with the belts or chains 590 may allow the wheelchair to also incorporate into either one or both of the drive gear/hub 550 and the push rim gear/hub 570 a multi-speed fixed-gear hub such as the Sturmey-Archer S3X fixed-gear hub, for example. In such implementations, the ability to switch to higher or lower speeds may allow the wheelchair user to go faster on smooth even terrain and to require less torque and forces on the shoulders to go up inclined terrain.

Additionally, in some implementations, the wheelchair 500 also includes a push rim repositioning member 580 that allows the push rim 510 to be repositioned to allow a user to transfer into and out of wheelchair 500 without having to lift himself over the push rim as shown in FIGS. 3A and 3B above. In the implementation shown in FIGS. 5A-5D, the repositioning member 580 is a release mechanism that allows the push rim 510 to be disconnected from the frame 505. For example, a quick release mechanism could be used to allow the push rim 510 to be removably attached to the frame 505. As shown in FIGS. 5A and 5B, the release mechanism (push rim repositioning member 580) holds the push rim 510 forward of a user's shoulders to allow propulsion of the wheelchair by the user (known as the propulsion position). As shown in FIGS. 5C and 5D, the release mechanism (push rim repositioning member 580) allows the push rim 510 to be disconnected from the frame 505, and once disconnected, the push rim 510 can be placed behind a user's shoulders to allow the user to transfer into and out of the wheelchair.

Though various aspects of this embodiment are shown in the figures and discussed above, implementations of this application are not limited to these aspects and alternative implementations are discussed below.

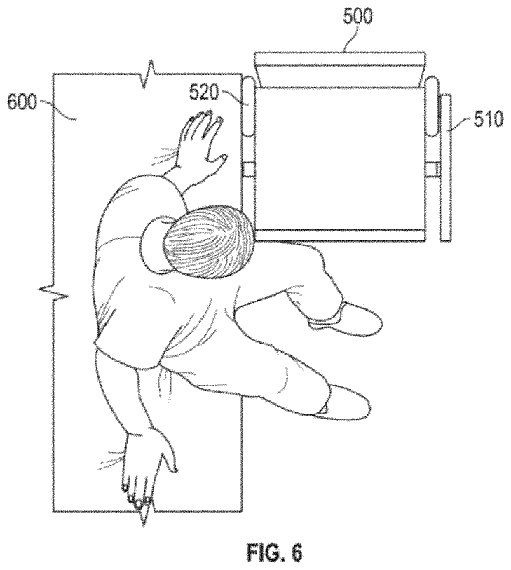

FIG. 6 is a top view illustrating an example transfer of a patient from a bed to a wheelchair according to an embodiment of the invention.

By incorporating a push rim reposition member, such as shown in the implementations of FIGS. 4A-4D and FIGS. 5A-5D, the wheelchair 500 can now be placed directly next to the bed 600 or other transfer surface, reducing the distance to transfer and also reducing the height to elevate the body since the user no longer needs to clear the wheel 520 or the push rim 510 or the combination.

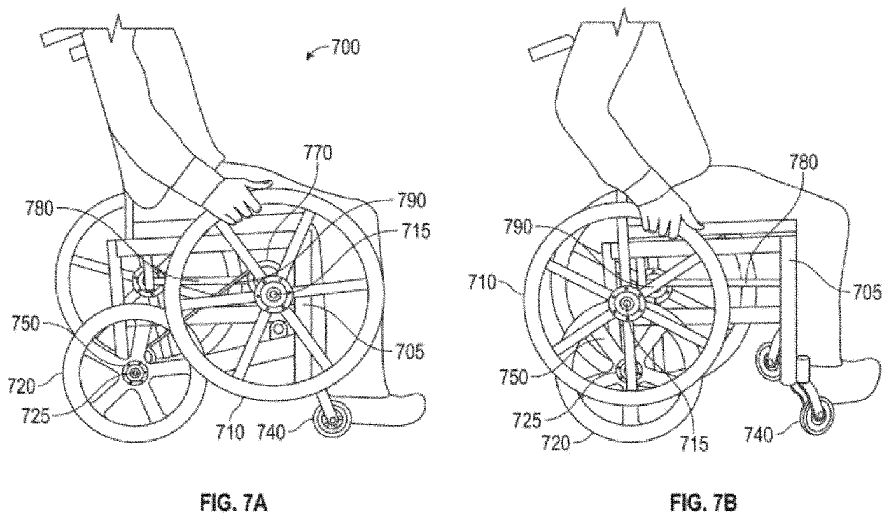

FIGS. 7A-7B are diagrams illustrating an example wheelchair with a push rim capable of being rotated backward and out of the way for transfers according to a third implementation of the present application. More specifically. FIG. 7A illustrates the wheelchair with the push rim to the wheelchair located in a propulsion position. Further, FIG. 7B illustrates the wheelchair with the push rim repositioned into a transfer position.

This implementation shown in FIGS. 7A and 7B may include features and elements similar to those discussed above with respect to the first and second implementations. Thus redundant descriptions thereof may be omitted. As with the implementations discussed above, in this implementation the wheelchair 700 includes a frame 705, a rotatable push rim 710 connected to the frame 705 and a drive wheel 720 connected to the frame 705. The wheelchair 700 may also include caster wheels 740 located in front of the drive wheel 720.

As shown in FIGS. 7A-7B, the axis of rotation 725 of the drive wheel 720 is offset from the axis of rotation 715 of the puss rim. Thus, instead of being directly coupled to each other, the push rim 710 and drive wheel 720 are connected by a transmission (not specifically labeled in FIGS. 7A and 7B; individual components labeled). The transmission may include a drive gear/hub 750 coupled to drive wheel 720, a push rim gear/hub 770 coupled to the push rim 710, and a chain or belt 790 connected to the drive gear/hub 750 and the push rim gear/hub 770.

Again, de-coupling the fore-aft position of the push rims 710 and drive wheels 720 may allow a clinician to place the drive wheels 720 in their optimal position to provide a stable base of support while still allowing the person to do “wheelies” if needed (to go over curbs and other thresholds). Also, the position of the push rims 710 can be set to promote the best positioning of the wheelchair 700 user's shoulders. A potential aspect of this more forward positioning of the push rims 710 is a reduction in shoulder pain resulting from manual propulsion of the wheelchair. In other words, de-coupling of the push rims 710 and drive wheels 720 may allow the clinician to place the push rims 720 in front of the user's center of gravity as shown in FIGS. 5A-5D, potentially improving mechanical efficiency without sacrificing wheelchair stability.

Again, the use of the transmission with the belts or chains 790 may allow the wheelchair to also incorporate a multi-speed fixed-gear hub to provide the ability to switch to higher or lower speeds and thereby allow the wheelchair user to go faster on smooth even terrain and to require less torque and forces on the shoulders to go up inclined terrain.

Additionally, in some implementations, the wheelchair 700 also includes a push rim repositioning member 780 that allows the push rim 710 to be repositioned to allow a user to transfer into and out of wheelchair 700 without having to lift himself over the push rim as shown in FIGS. 3A and 3B above. In FIGS. 7A-7B, the repositioning member 580 is a guide rail extending along the frame 705 that the push rim 710 can be slid along. Thus, the push rim 710 may be slidingly mounted to the guide rail (push rim repositioning mechanism 780) and repositioned at different portions along the length of the guide rail (push rim repositioning mechanism 780). As shown in FIGS. 7A, the push rim 710 has been slid forward along the guide rail (push rim repositioning mechanism 780) to be located forward of a user's shoulders to allow the propulsion of the wheel chair by the user (known as the propulsion position). As shown in FIGS. 7B, the push rim 710 has been slid backward along the guide rail (push rim repositioning mechanism 780) to be located behind or even with a user's shoulders to allow the user to transfer into and out of the wheelchair.

Additionally, in some implementations, a locking mechanism (not shown) may be provided to releasably hold the push rim 710 (swing arm) in the propulsion position located in front of the user's shoulders as shown in FIG. 7A. Further, a second locking mechanism (not shown) or hard stop may also be provided to releasably hold or limit the rearward movement of the push rim 710 in the transfer position shown in FIG. 7B. Additionally, in some embodiments, the transmission of the wheel chair may also include an idler sprocket (not shown), which can be used to maintain a fixed tension in the belt or chain 790.

Though various aspects of this embodiment are shown in the figures and discussed above, implementations of this application are not limited to these aspects and alternative implementations are discussed below.

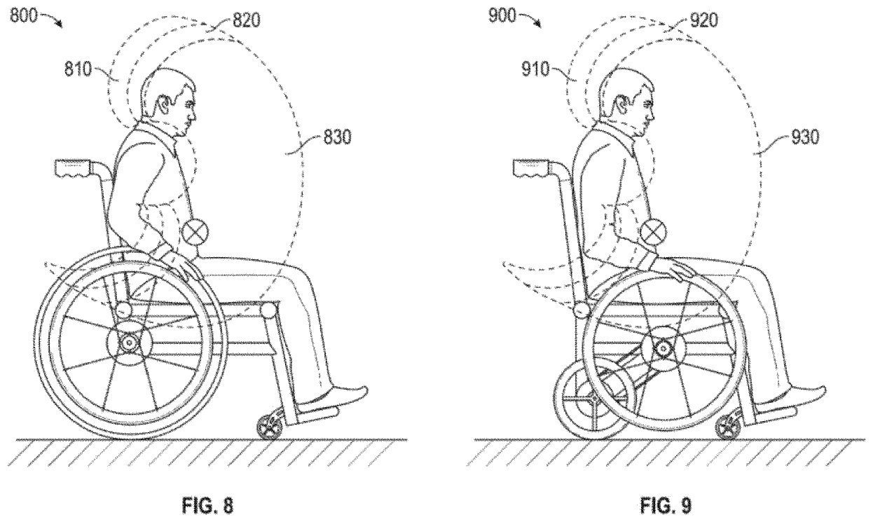

FIG. 8 illustrates the reachable workspace of a user's wrist for different shoulder ranges of motion laid over a diagram of an example wheelchair 800 and FIG. 9 illustrates the reachable workspace of a user's wrist for different shoulder ranges of motion laid over a diagram of a wheelchair 900 according to an implementation of the present application. As discussed above, a problem with conventional wheelchairs relates to the positioning of the drive wheel/push rim assembly relative to the user's shoulders. Rearward placement of the drive wheel/push rim assembly can improve stability, but such placement can require a user to continually reach backward with shoulder extension and sometimes shoulder abduction. Use of the shoulders in excessive extension and in abduction are thought to be damaging for repeated use. Also, some users may have experienced reduced range of motion that can limit the propulsive three that can be generated by the user. FIGS. 8 and 9 illustrate a hypothetical user's range of motion laid over diagrams of a wheelchair 800 and a wheelchair 900 according to an implementation of the present application. Specifically, in FIGS. 8 and 9, regions 810, 910 represent a user with a full range of motion, regions 820, 920 represent a user with a slightly reduced range of motion, and regions 830, 930 represent a reduced range of motion. As shown in FIG. 8, in order to achieve and maximize the arc of propulsion by starting the application of torque at the upper surface of the push rim of the conventional wheel chair, the user needs to take his shoulders into large angles of extension (i.e. into region 810). However, by moving the push rims forward in an implementation according to the present application, the user may be able to apply a maximum arc of propulsion with less shoulder extension (i.e. outside region 910, and into regions 920, 930).

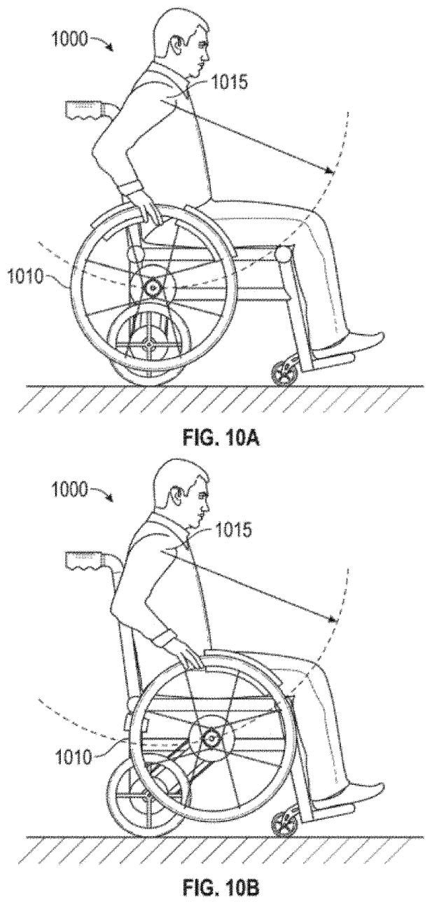

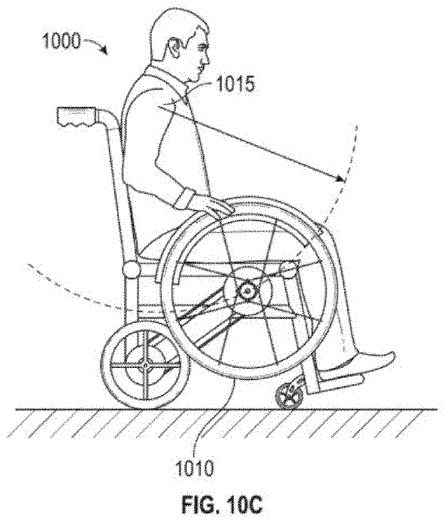

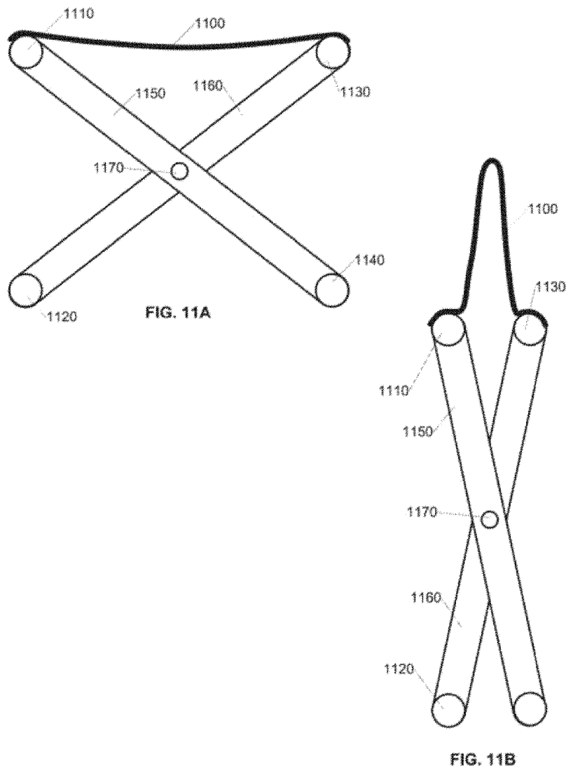

In the implementations discussed above, the push rim was shown being movable between a propulsion position and a transfer position. However, implementations of the present invention need not have only two positions. Instead, a wheelchair according to the present application may include a push rim repositioning mechanism configured to allow customizable placement of the push rim based on a user's specific physical dimensions ands or physical capabilities and/or the activities that the patient is involved in. FIGS. 10A-10C illustrate placement of a push rim at various positions along a wheelchair according to an implementation of the present application based on a user's range of motion. FIG. 10A illustrates the push rim 1010 of the wheelchair 1000 in position even with the user's shoulders 1015. FIG. 10B illustrates the push rim 1010 of the wheelchair 1000 rotated forward by 15 degrees with respect to the user's shoulders 1015. FIG. 10C illustrates the push rim 1010 of the wheelchair 1000 rotated forward by 15 degrees with respect to the user's shoulders 1015.

FIGS. 11A-27 illustrate a collapsible implementation of the present application. It should be noted that in order to simplify the description, only one side of the collapsible wheelchair is illustrated and described. However, as will be understood by the skilled artisan, the collapsible wheelchair can be implemented having mirror parts and functionality on the opposite side of the wheelchair. Alternatively, the opposite side of the wheelchair may be implemented with different parts and functionality to provide increased usability. For example, one side of the wheelchair may include a push rim that rotates backward while the other side of the wheelchair may include a removable push rim. All of the various combinations of the functionality disclosed herein are contemplated by the inventors as acceptable combinations.

FIGS. 11A-11B are front view diagrams illustrating a collapsible wheelchair frame. In the illustrated embodiment of FIG. 11A, the wheelchair frame comprises a seat base 1100, a first lateral frame member 1110, a second lateral frame member 1120, a third lateral frame member 1130, a fourth lateral frame member 1140, a first cross frame member 1150 and a second cross frame member 1160. The first and second cross frame members 1150, 1160 are connected via a collapsible axis 1170 that allows the cross frame members 1150, 1160 to rotate with respect to each other about the collapsible axis 1170.

In the illustrated embodiment of FIG. 11B, the wheelchair frame is collapsed by rotating the first cross frame member 1150 and the second cross frame member 1160 with respect to each other about the collapsible axis 1170 resulting in a greater distance between the first lateral frame member 1110 and the second lateral frame member 1120, a closer distance between the first lateral fame member 1110 and the third lateral frame member 1130 and elevation of the seat base 1100.

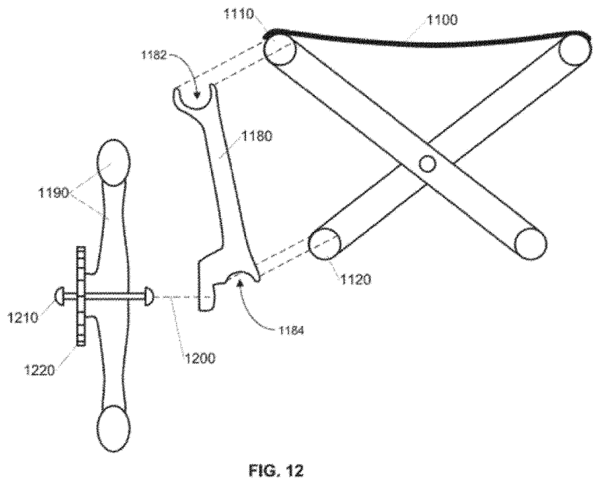

FIG. 12 is an expanded view diagram illustrating an example drive wheel 1190 and first brace 1180 according to an implementation of the present application. In the illustrated embodiment, the first brace 1180 comprises a first brace upper recess 1182 and a first brace lower recess 1184. The first brace upper recess 1182 and first brace lower recess 1184 are configured to attach to the first lateral frame member 1110 and the second lateral frame member 1120, respectively. In one embodiment, the first brace lower recess 1184 is configured to release the second lateral frame member 1120 when the wheelchair is collapsed. In an alternative embodiment, the first brace upper recess 1182 is configured to release the first lateral frame member 1110 when the wheelchair is collapsed. In another alternative embodiment, both of the first brace lower recess 1184 and the first brace upper recess 1182 are configured to release the second lateral frame member 1120 and the first lateral frame member 1110, respectively, when the wheelchair is collapsed.

Also in the illustrated embodiment, the drive wheel 1190 (comprising both a perimeter tire and a wheel) rotates about the drive wheel axis of rotation 1200. A drive wheel axle 1210 is positioned along the drive wheel axis of rotation 1200 and extends through a drive wheel sprocket 1220 and the drive wheel 1190.

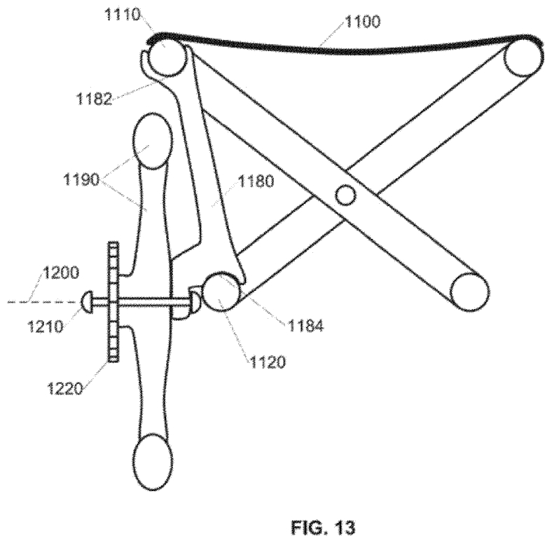

FIG. 13 is a front view diagram illustrating an example drive wheel 1190 connected to first brace 1180 of a wheelchair frame according to an implementation of the present application. In the illustrated embodiment, the drive wheel 1190 and the drive wheel sprocket 1220 rotate with respect to the wheelchair frame about the drive wheel axle 1210 that is positioned along the drive wheel axis of rotation 1200. The drive wheel axle 1210 extends through the drive wheel sprocket 1220, the drive wheel 1190 and the first brace 1180 in order to secure the drive wheel 1190 to the first lateral frame member 1110 and the second lateral frame member 1120 of the wheelchair frame. The first brace upper recess 1182 engages the first lateral frame member 1110 and the first brace lower recess 1184 engages the second lateral frame member 1120 when the wheelchair is not collapsed.

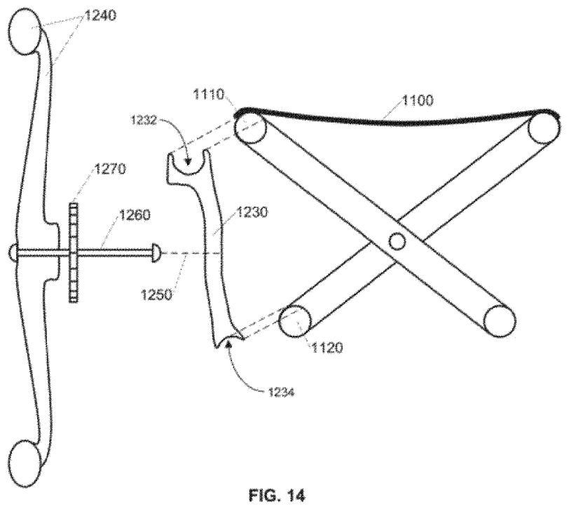

FIG. 14 is an expanded view diagram illustrating an example push rim 1240 and second brace 1230 according to an implementation of the present application. In the illustrated embodiment, the second brace 1230 comprises a second brace upper recess 1232 and a second brace lower recess 1234. The second brace upper recess 1232 and second brace lower recess 1234 are configured to attach to the first lateral frame member 1110 and the second lateral frame member 1120, respectively. In one embodiment, the second brace lower recess 1234 is configured to release the second lateral frame member 1120 when the wheelchair is collapsed. In an alternative embodiment, the second brace upper recess 1232 is configured to release the first lateral frame member 1110 when the wheelchair is collapsed. In another alternative embodiment, both of the second brace lower recess 1234 and the second brace upper recess 1232 are configured to release the second lateral frame member 1120 and the first lateral frame member 1110, respectively, when the wheelchair is collapsed.

Also in the illustrated embodiment, the push rim 1240 rotates about the push rim axis of rotation 1250. A push rim axle 1260 is positioned along the push rim axis of rotation 1250 and extends through a push rim sprocket 1270 and the push rim 1240.

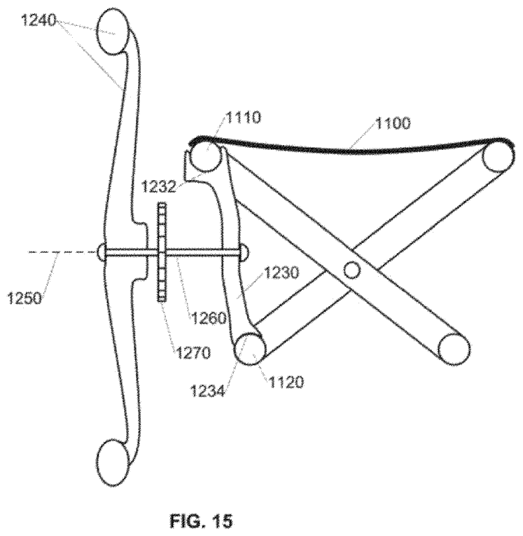

FIG. 15 is a front view diagram illustrating an example push rim 1240 and second brace 1230 connected to a wheelchair frame according; to an implementation of the present application. the illustrated embodiment, the push rim 1240 and the push rim sprocket 1270 rotate with respect to the wheelchair frame about the push rim axle 1260 that is positioned along the push rim axis of rotation 1250. The push rim axle 1260 extends through the push rim sprocket 1270, the push rim 1240 and the second brace 1230 in order to secure the push rim 1240 to the first lateral frame member 1110 and the second lateral frame member 1120 of the wheelchair frame. The second brace upper recess 1232 engages the first lateral frame member 1110 and the second brace lower recess 1234 engages the second lateral frame member 1120 when the wheelchair is not collapsed.

FIG. 16 is an expanded view diagram illustrating an example drive wheel 1190 and first brace 1180 combined with an example push rim 1240 and second brace 1230 according to an implementation of the present application. In the illustrated embodiment, first brace upper recess 1182 and the second brace upper recess 1232 are configured to engage the first lateral frame member 1110 and the first brace lower recess 1184 and the second brace lower recess 1234 are configured to engage the second lateral frame member 1120.

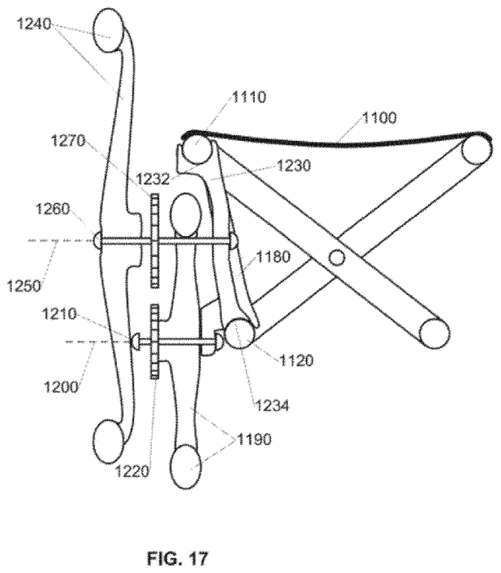

FIG. 17 is a front view diagram illustrating an example drive wheel 1190 and first brace 1180 combined with an example push rim 1240 and second brace 1230 and connected to the first lateral frame member 1110 and the second lateral frame member 1120 of a wheelchair frame according to an implementation of the present application. In the illustrated embodiment, the drive wheel 1190 rotates with respect to the wheelchair frame about the drive wheel axis 1200. The drive wheel axle 1210 extends along the drive wheel axis 1200 through the drive wheel 1190 and the drive wheel sprocket 1220 and through a lower portion of the first brace 1180.

Also in the illustrated embodiment, the push rim 1240 rotates with respect to the wheelchair frame about the push rim axis 1250. The push rim axle 1260 extends along the push rim axis 1250 through the push rim 1240 and the push rim sprocket 1270 and through a middle portion of the second brace 1230.

Also in the illustrated embodiment, first brace upper recess 1182 and the second brace upper recess 1232 each engage the first lateral frame member 1110 and the first brace lower recess 1184 and the second brace lower recess 1234 each engage the second lateral frame member 1120. When the first brace upper recess 1182 and the second brace upper recess 1232 are both engaged with the first lateral frame member 1110 and the first brace lower recess 1184 and the second brace lower recess 1234 are both engaged with the second lateral frame member 1120, the wheelchair is not collapsed.

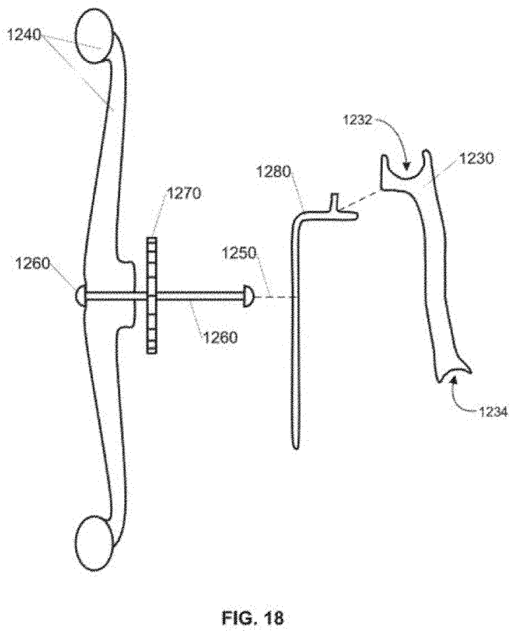

FIG. 18 is an expanded view diagram illustrating an example push rim 1240 and drive chain guard 1280 and second brace 1230 according to an implementation of the present application, in the illustrated embodiment, the drive train guard 1280 is configured to engage a portion of the second brace 1230 proximal the second brace upper recess 1232. In one embodiment, the drive train guard 1280 is configured to engage the second brace 1230 and carry at least a portion of the downward force that would otherwise be carried by the second brace 1230. Any force the drive train guard 1280 receives from the second brace 1230 is delivered to the drive wheel 1190 by way of the drive wheel axle 1210. The push rim axle 1260 is configured to extend through holes in each of the push rim 1240 and the push rim sprocket 1270 and the drive chain guard 1280 and through a hole in the middle portion of the second brace 1230 to secure the push rim 1240 to the frame of the collapsible wheelchair. The drive chain guard 1280 advantageously separates and protects the user from the moving parts of the drive train 1290 during operation of the manual wheelchair.

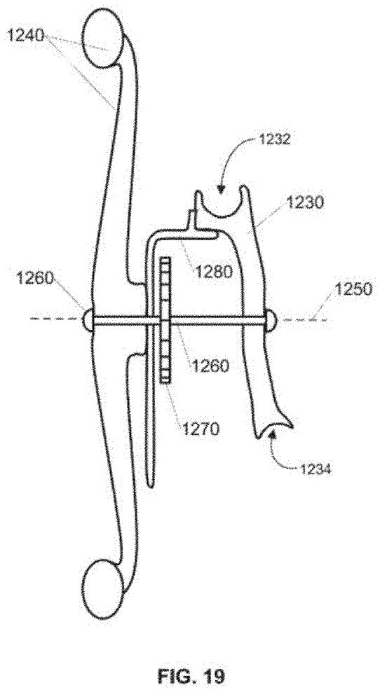

FIG. 19 a front view diagram illustrating an example push rim 1240 and drive chain guard 1280 and second brace, 1230 connected to a wheelchair frame according to an implementation of the present application. In the illustrated embodiment, the push rim 1240 rotates about the push rim axis 1250 and is secured to the second brace 1230 via the push rim axle 1260, which extends along the push rim axis 1250 through the push rim 1240, the drive train guard 1280, the push rim sprocket 1270 and the second brace 1230.

FIG. 20 is a front view diagram illustrating an example drive wheel 1190 and first brace 1180 combined with an example push rim 1240 and drive chain guard 1280 and second brace 1230. The first brace 1180 and the second brace 1230 are each connected to the first lateral member 1110 and the second lateral member 1120 of a wheelchair frame according to an implementation of the present application.

In the illustrated embodiment, the drive train guard 1280 is configured to engage the second brace 1230 proximal to the second brace upper recess. The drive train guard 1280 also includes two or more through holes to allow at least the push rim axle 1260 and the drive wheel axle 1210 to pass through the drive train guard 1280. The drive train guard 1280 may or may not be configured to deliver a portion of the downward force that would otherwise be carried by the second brace 1230 to the drive wheel axle 1210. The drive wheel axle 1210 is configured to extend through holes in each of the drive wheel 1190 and the drive wheel sprocket 1220 and the drive chain guard 1280 and through a hole in the first brace 1180 proximal to the second lateral frame member 1120 when the wheelchair is not collapsed. The drive wheel axle 1210 thereby secures the drive wheel 1190 to the frame of the collapsible wheelchair. The drive chain guard 1280 advantageously separates and protects the user from the moving parts of the drive train 1290 during operation of the manual wheelchair.

Although the illustrated embodiment shows the drive train 1290 components between the push rim 1240 and the drive wheel 1190, in an alternative embodiment, the push rim 1240, the drive train 1290 and the drive wheel 1190 can be in any order. For example, in one embodiment, the push rim 1240 is positioned on the outside and the drive wheel 1190 is positioned between the push rim 1240 and the drive train 1290. It is preferred that the drive train guard 1280 separate the operator from drive train 1290 and the drive wheel 1190 in order to protect the operator from those moving parts during operation of the manual wheelchair.

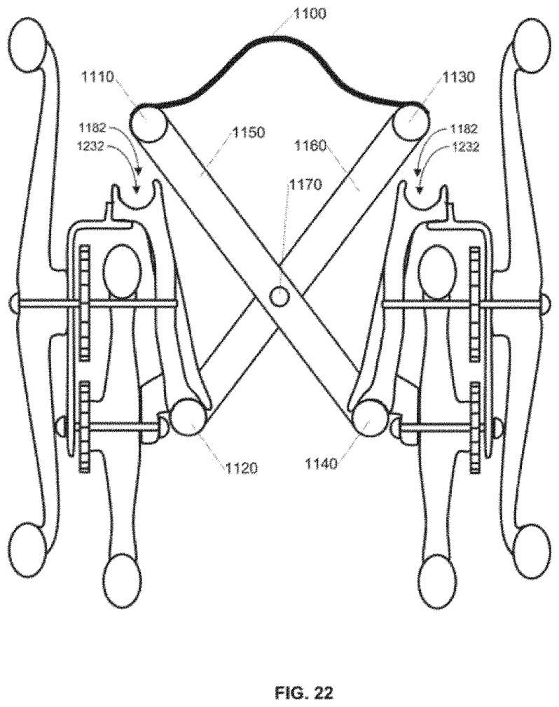

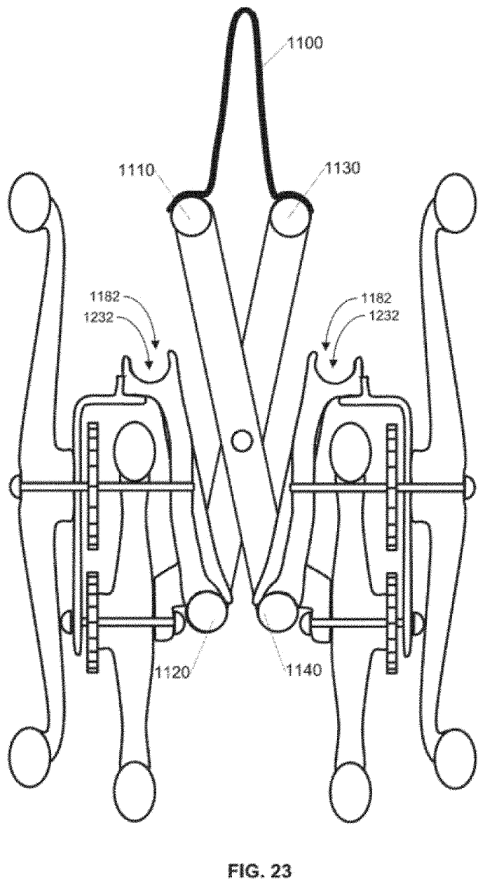

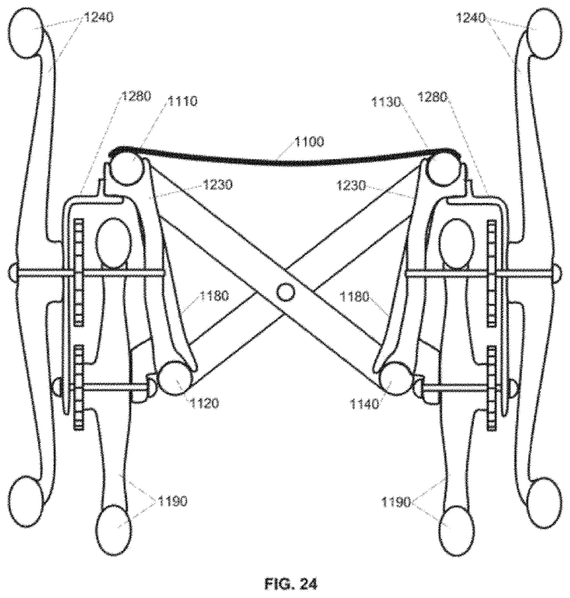

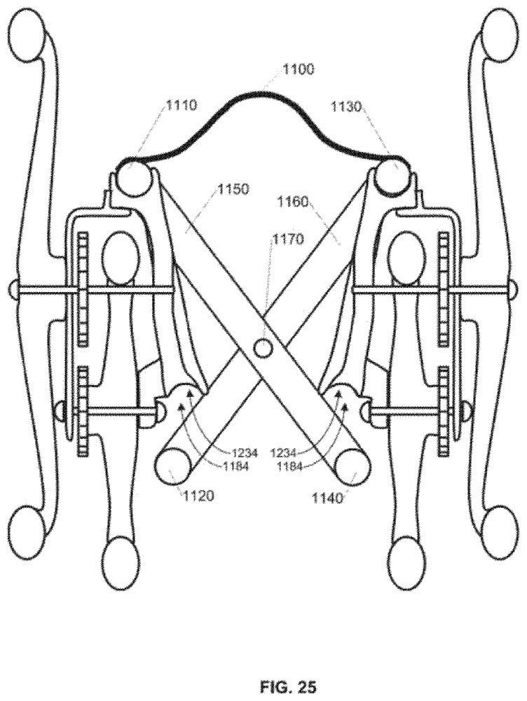

FIGS. 21-23 are front view diagrams illustrating an example collapsible wheelchair having first and second braces 1180, 1230 that release the first lateral member 1110 according to an implementation of the present application. In the illustrated embodiment, FIG. 21 shows the collapsible wheelchair with mirror parts on both sides of the wheelchair and the first and second braces 1180, 1230 are engaged with the first and second lateral members 1110, 1120. FIG. 22 shows the collapsible wheelchair after the first and second braces 1180, 1230 have released, the first lateral member 1110 and the first and second cross frame members 1150 and 1160 have rotated about the collapsible axis 1170 to increase the distance between the first lateral frame member 1110 and the second lateral frame member 1120. FIG. 23 shows the collapsible wheelchair after the first and second cross frame members 1150 and 1160 have rotated further about the collapsible axis 1170 to place the manual wheelchair into the collapsed configuration. Notably, the first brace upper recess 1182 and the second brace upper recess 1232 are not engaged with the first lateral frame member 1110 when the manual wheelchair is in the collapsed configuration as shown.

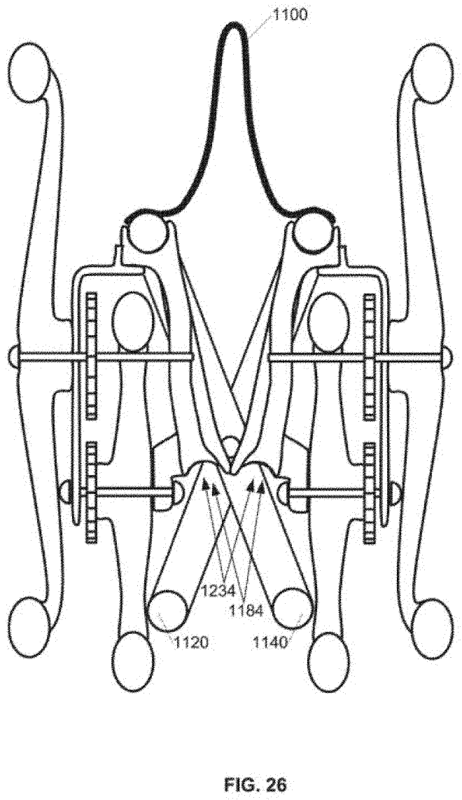

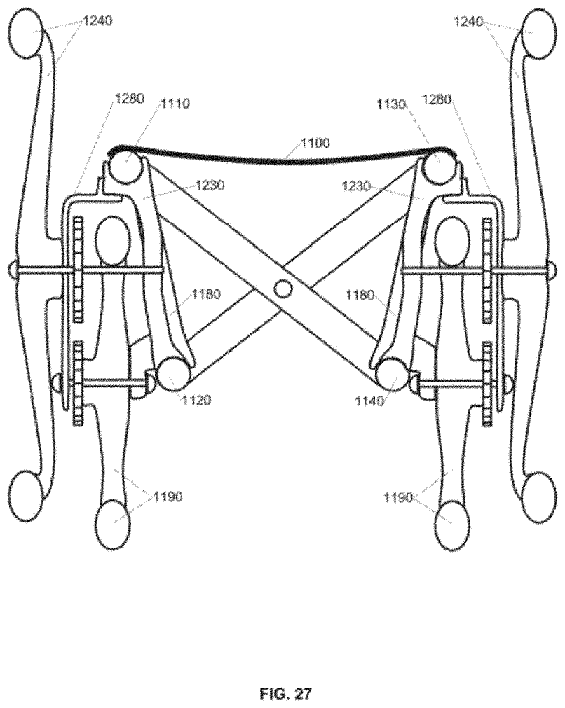

FIGS. 24-26 are front view diagrams illustrating an example collapsible wheelchair having first and second braces 1180, 1230 that release the second lateral member 1120 according to an it of the present application. In the illustrated embodiment, FIG. 24 shows the collapsible wheelchair with mirror parts on both sides of the wheelchair and the first and second braces 1180, 1230 are engaged with the first and second lateral members 1110, 1120. FIG. 25 shows the collapsible wheelchair after the first and second braces 1180, 1230 have released the second lateral member 1120 and the first and second cross frame members 115 and 1160 have rotated about the collapsible axis 1170 to increase the distance between the first lateral frame member 1110 and the second lateral frame member 1120. FIG. 26 shows the collapsible wheelchair after the first and second cross frame members 1150 and 1160 have rotated further about the collapsible axis 1170 to place the manual wheelchair into the collapsed configuration. Notably, the first brace lower recess 1184 and the second brace lower recess 1234 are not engaged with the second lateral frame member 1120 when the manual wheelchair is in the collapsed configuration as shown.

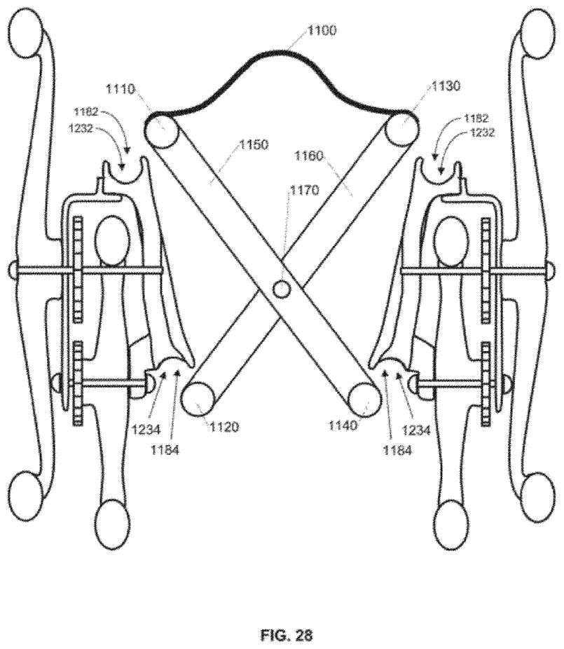

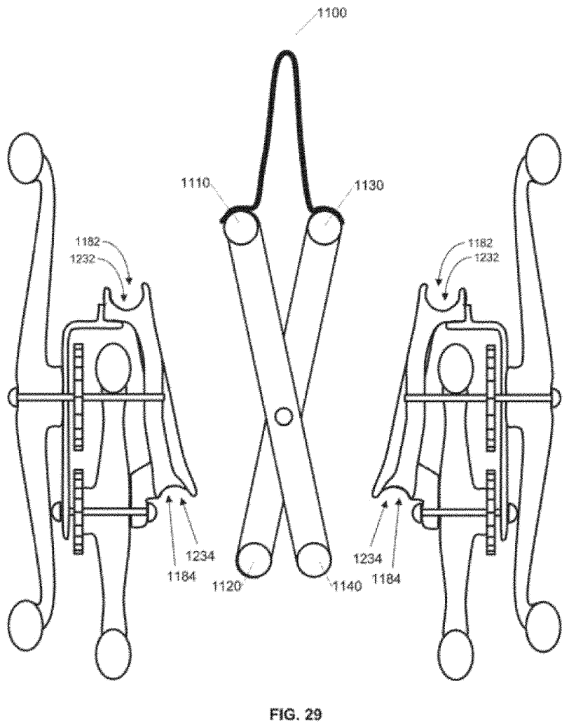

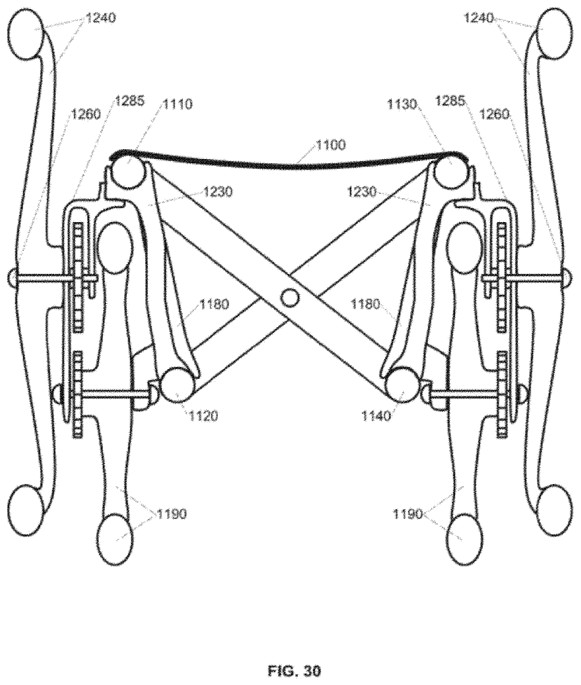

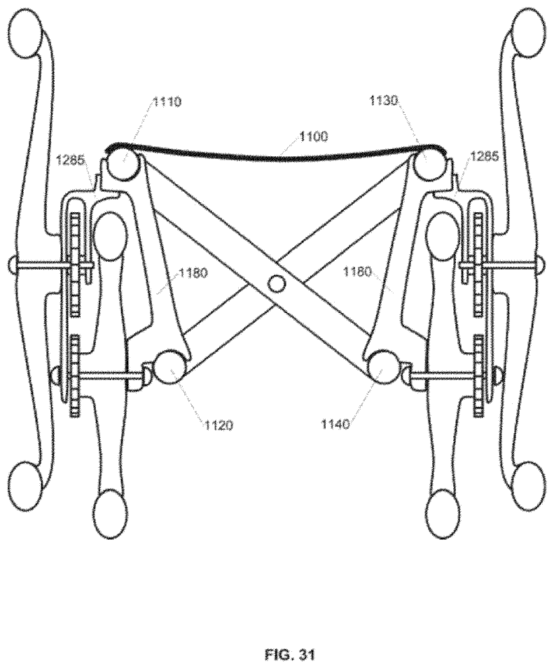

FIGS. 27-29 are front view diagrams illustrating an example collapsible wheelchair having first and second braces 1180, 1230 that release the first and second lateral members 1110, 1120 according to an implementation of the present application. In the illustrated embodiment, FIG. 27 shows the collapsible wheelchair with mirror parts on both sides of the wheelchair and the first and second braces 1180, 1230 are engaged with the first and second lateral members 1110, 1120. FIG. 28 shows the collapsible wheelchair after the first and second braces 1180, 1230 have released the first lateral member 1110 and the second lateral member 1120 and the first and second cross frame members 1150 and 1160 have rotated about the collapsible axis 1170 to increase the distance between the first lateral frame member 1110 and the second lateral frame member 1120. In FIG. 28, it is clear that the collapsible wheelchair separates into three separate portions after the first and second lateral members 1110, 1120 have been released by the first and second braces 1180, 1230, FIG. 29 shows the collapsible wheelchair after the first and second cross frame members 1150 and 1160 have rotated further about the collapsible axis 1170 to further compress the cross frame member section of the collapsible wheelchair. Notably, the first and second braces upper recesses 1182, 1232 and the first and second braces lower recess 1184, 1234 are not engaged with the first and second lateral frame members 1110, 1120 when the manual wheelchair is in the collapsed configuration as shown.

FIG. 30 is a front view diagram illustrating an example collapsible wheelchair having a drive train guard fork 1285 according to an implementation of the present application, In the illustrated embodiment, the fork 1285 includes an upper section that is configured to engage the second brace 1230. The fork 1285 also includes two extensions that extend down train the upper section on either side of the drive wheel sprocket 1220. A first extension of the fork 1285 extends down on a first side of the drive wheel sprocket 1220 that is adjacent to the push rim 1240. A second extension of the fork 1285 extends down on a second side of the drive wheel sprocket 1220 adjacent to the drive wheel 1190. Accordingly, the first extension of the fork 1285 functions at least in part as a drive train guard and the overall fork 1285 functions at least in part to translate a portion of the weight carried by the manual wheelchair from the first later member 1110 to the drive wheel 1190 via the drive wheel axle 1210.

The second extension of the fork 1285 additionally has a through hole aligned with the push rim axis of rotation 1250 to allow the push rim axle 1260 to extend through the push rim 1240, the first extension of the fork 1285, the push rim sprocket 1270 and the second extension of the fork 1285. Advantageously, the push rim axle can be secured on a first end to an outer surface of the push rim 1240 and can also be secure on a second end to an inner surface of the second extension of the fork 1285. Additionally, coupling the push rim axle 1260 to the push rim 1240 and the fork 1285 allows the push rim 1240 to be located in a variety of positions with respect to the drive wheel 1190 without interference with the operation of the drive wheel 1190.

In one embodiment, the collapsible wheelchair configured with a fork 1285 may eliminate one of the first or second braces 1180, 1230. FIG. 31 is a front view diagram illustrating an example collapsible wheelchair having a drive train guard fork 1285 and a single brace 1180 according to an implementation of the present application.

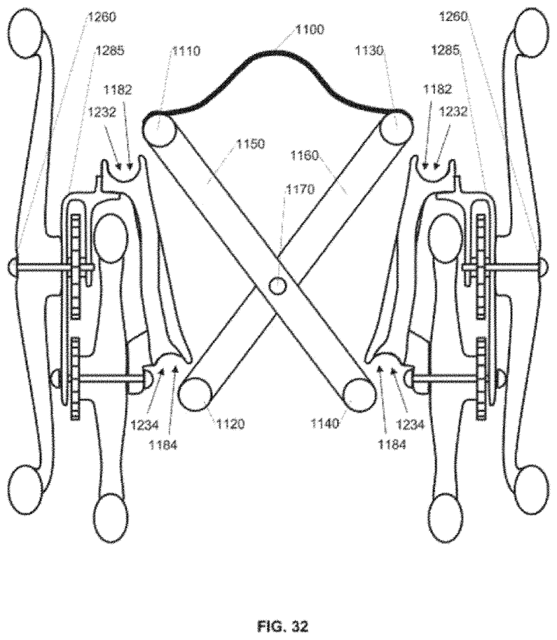

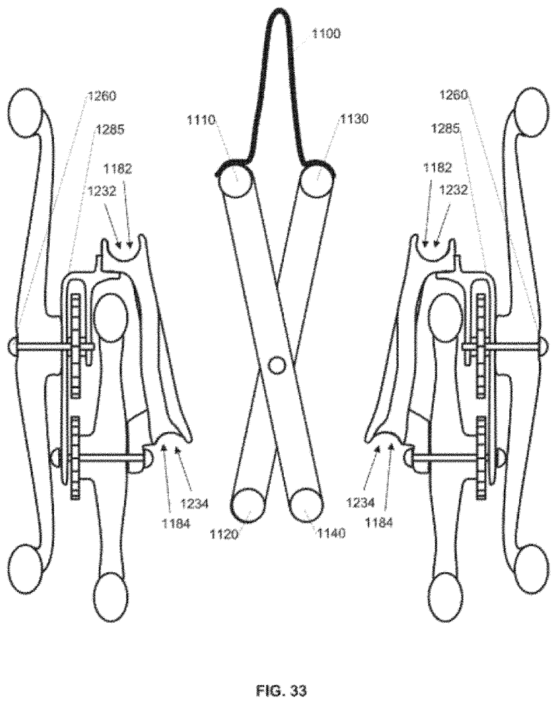

FIGS. 32-33 are front view diagrams illustrating an example collapsible wheelchair having a drive train guard fork 1285 and first and second braces 1180, 1230 that release the first and second lateral members 1110, 1120 according to the implementation of FIG. 30, which shows the collapsible wheelchair with mirror parts on both sides of the wheelchair and the first and second braces 1180, 1230 are engaged with the first and second lateral members 1110, 1120. FIG. 32 shows the collapsible wheelchair after the first and second braces 1180, 1230 have released the first lateral member 1110 and the second lateral member 1120 and the first and second cross frame members 1150 and 1160 have rotated about the collapsible axis 1170 to increase the distance between the first lateral frame member 1110 and the second lateral frame member 1120. In FIG. 32, it is clear that the collapsible wheelchair separates into three separate portions after the first and second lateral members 1110, 1120 have been released by the first and second braces 1180, 1230. FIG. 33 shows the collapsible wheelchair after the first and second cross frame members 1150 and 1160 have rotated further about the collapsible axis 1170 to further compress the cross frame member section of the collapsible wheelchair. Notably, the first and second braces upper recesses 1182, 1232 and the first and second braces lower recess 1184, 1234 are not engaged with the first and second lateral frame members 1110, 1120 when the manual wheelchair is in the collapsed configuration as shown.

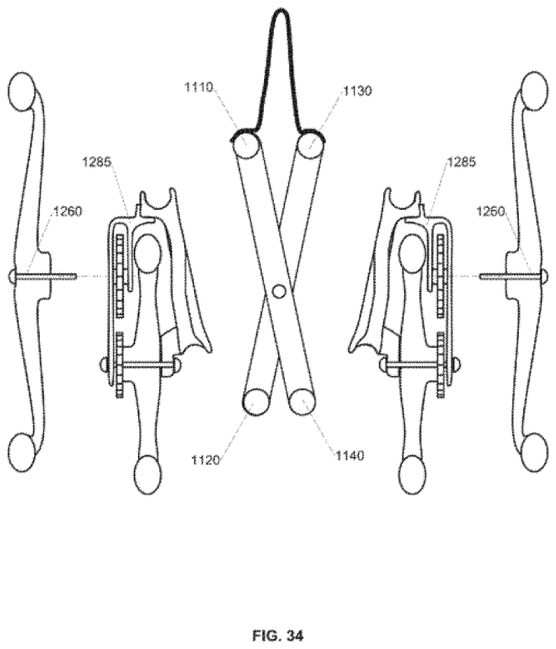

FIG. 34 is a front view diagram illustrating an example collapsible wheelchair having a drive train guard fork 1285 and a removable push rim 1240 according to an implementation of the present application. In the illustrated embodiment, the push rim 1240 is removable from the collapsible wheelchair by disengaging the push rim axle 1260 from the second extension of the drive train guard fork 1285 and sliding the push rim 1240 and push rim axle 1260 away from the wheelchair to cause the push rim axle 1260 to exit each of the through holes in the first and second extensions of the drive train guard fork 1285 and the push rim sprocket 1270. Advantageously, the entire collapsible wheelchair can be easily separated into at least five separate parts for convenient and compact storage.

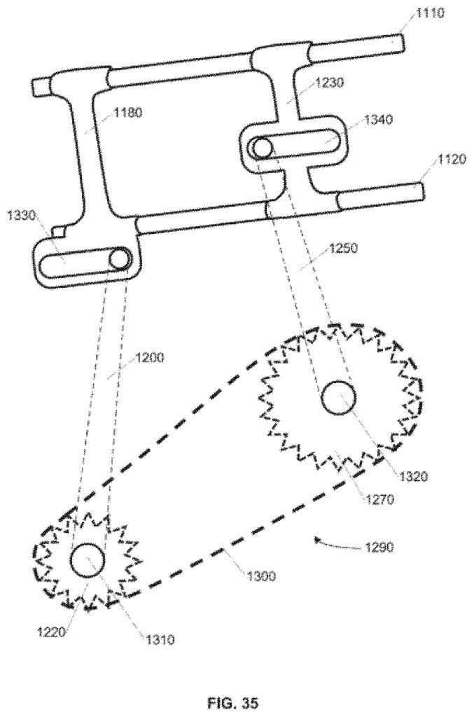

FIG. 35 is an expanded side view diagram illustrating an example drive train 1290 orientation with respect to the first brace 1180 and the second brace 1230 and the first and second axes 1200, 1250 of rotation according to an implementation of the present application, In the illustrated embodiment the drive train 1290 comprises the drive wheel axle 1210 and the drive wheel sprocket 1220, the push rim axle 1260 and the push rim sprocket 1270, and the chain belt 1300.

In one embodiment, the first brace 1180 comprises a first brace axle slot 1330 to allow the drive wheel axle 1210 to pass through and be secured to the first brace 1180. The drive wheel sprocket 1220 comprises a corresponding drive wheel sprocket through hole 1310 to allow the opposite end of the drive wheel axle 1210 to pass through and be secured to the drive wheel 1190. The combination of the drive wheel sprocket through hole 1310 and the first brace axle slot 1330 allows the operator to select relative positions for the drive wheel sprocket 1220 and the push rim sprocket 1270 that provide optimal tension on the chain/belt 1300 during operation of the manual wheelchair.

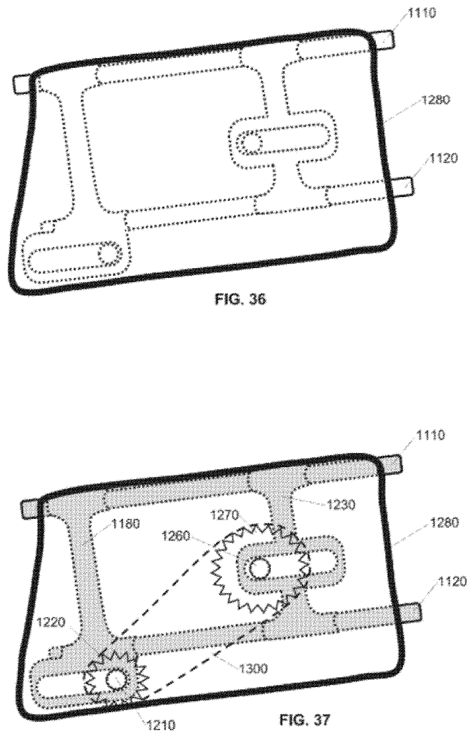

FIG. 36 is a side view diagram illustrating an example drive train guard 1280 orientation with respect to first and second lateral frame members 1110, 1120 according to an implementation of the present application. In the illustrated embodiment, the drive train guard 1280 is secured along a portion of the surface of the first lateral frame member 1110 and is also secured to the manual wheelchair by the drive wheel axle 1210 and the push rim axle 1260 that each pass through a portion of a middle section of the drive train guard 1280.

FIG. 37 is a side view diagram illustrating an example drive train guard 1280 orientation with respect to first and second lateral frame members 1110, 1120 and the drive train 1290 according to an implementation of the present application. In the illustrated embodiment, the drive wheel sprocket 1220 and the push rim sprocket 1270 are secured to the first brace 1180 and the second brace 1230 by way of the drive wheel axle 1210 and the push rim axle 1260. The drive train guard 1280 advantageously separates the operator of the wheelchair from the moving parts of the drive train 1290 during operation of the manual wheelchair.

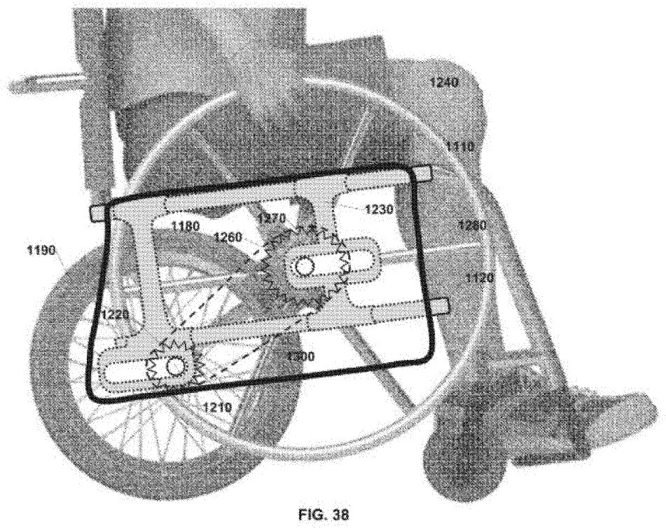

FIG. 38 is a side view diagram illustrating an example drive train guard 1280 orientation with respect to first and second lateral frame members 1110, 1120, the drive train 1290, the drive wheel 1190, the push rim 1240 and a collapsible manual wheelchair according to an implementation of the present application. In the illustrated embodiment, the drive wheel sprocket 1220 and the push rim sprocket 1270 are secured to the first brace 1180 and the second brace 1230 by way of the drive wheel axle 1210 and the push rim axle 1260. The drive train guard 1280 advantageously separates the operator of the wheelchair from the moving parts of the drive train 1290 during, operation of the manual wheelchair.

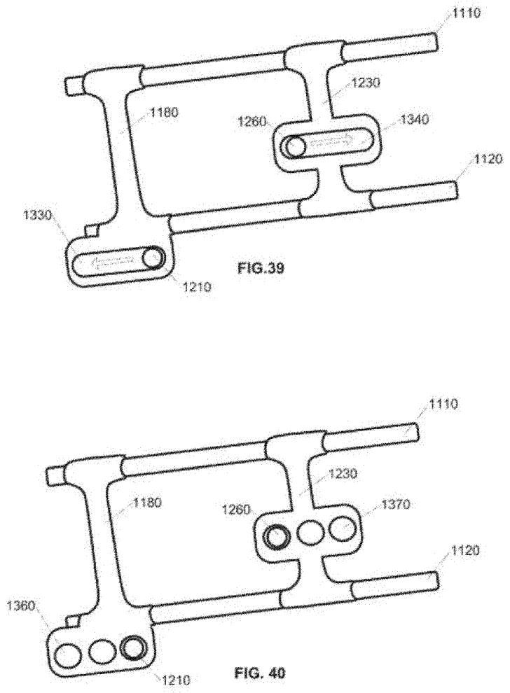

FIG. 39 is a side view diagram illustrating first and second braces 1180, 1230 having variable axle position slots 1330, 1340, respectively, according to an implementation of the present application. In the illustrated embodiment, the variable axle position slot 1330 of the first brace 1180 allows the operator of the manual wheelchair to select a preferred or optimal position for orientation of the drive wheel 1190 relative to the push rim 1240. Similarly, the variable axle position slot 1340 of the second brace 1230 allows the operator of the manual wheelchair to select a preferred or optimal position for orientation of the push rim 1240 relative to the drive wheel 1190. For example, during operation of the manual wheelchair, the operator may select the relative positions to provide optimal tension on the chain/belt 1300 for ease of propulsion. Alternatively, the operator may also select the relative positions to provide ease of ingress/egress to/from the manual wheelchair.

FIG. 40 is a side view diagram illustrating first and second braces 1180, 1230 having plural fixed axle positions 1360, 1370, respectively, according to an implementation of the present application. In the illustrated embodiment, the first brace 1180 comprises a plurality of fixed position holes 1360 through which the drive wheel axle 1210 may be passed to secure the drive wheel 1190 to the first brace 1180 and thus the frame of the manual wheelchair. In one embodiment, there may be three fixed position holes 1360 but in alternative embodiments there may be more or less than three. Similarly, the second brace 1230 also comprises a plurality of fixed position holes 1370 through which the push rim axle 1260 may be passed to secure the push rim 1240 to the second brace 1230 and thus the frame of the manual wheelchair. In one embodiment, there may be three fixed position holes 1370 but in alternative embodiments there may be more or less than three.

Further optional aspects of wheelchairs in accordance with embodiments disclosed herein are disclosed in U.S. Patent Application Publication No. 2019/0133854 to Hansen et at., filed May 5, 2015, the entirety of which is hereby incorporated by reference herein.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A drive assembly for a wheelchair having a frame and a plurality of wheels rotatably attached to the frame, the drive assembly comprising: a motor; a power source that is configured to power the motor; a drive shaft that is coupled to the motor; a first sprocket that is coupled to the drive shaft; a second sprocket that is configured to be rotationally fixed to a wheel of the plurality of wheels; a drive belt or chain that extends between the first sprocket and the second sprocket; and an input device that is configured to receive an input from an operator and, in response to receiving the input, one of provide a control signal for controlling an output of the motor or create an electrical coupling that provides power to the motor.

Aspect 2: The drive assembly of aspect 1, further comprising a clutch that is configured to selectively engage and disengage the motor from the wheel.

Aspect 3: The drive assembly of aspect 2, wherein the clutch is a centrifugal clutch.

Aspect 4: The drive assembly of aspect 2, wherein the input device is configured to provide a signal to the clutch in response to receiving the input from the operator, wherein the clutch is configured to engage upon receiving the signal from the input device.

Aspect 5: The drive assembly of any one of the preceding aspects, wherein the input device comprises a variable speed throttle.

Aspect 6: The drive assembly of any one of aspects 1-4, wherein the input device comprises a switch, wherein the input is a change in state of the switch, wherein the state of the switch is one of closed and open.

Aspect 7: The drive assembly of any one of the preceding aspects, wherein the input device comprises a lever.

Aspect 8: The drive assembly of any one of the preceding aspects, wherein the motor has a power output that is less than 200 watts.

Aspect 9: The drive assembly of any one of the preceding aspects, wherein the power source is a battery that is releasable by a push button detent.

Aspect 10: The drive assembly of any one of the preceding aspects, wherein the drive assembly has a. total weight of less than 3.0 kg.

Aspect 11: A wheelchair comprising: a frame; a plurality of wheels rotatably attached to the frame; a motor coupled to the frame; a power source that is configured to power the motor; a drive shaft that is coupled to the motor; a first sprocket that is coupled to the drive shaft; a second sprocket that is rotationally fixed to a wheel of the plurality of wheels; a drive belt or chain that extends between the first sprocket and the second sprocket; and an input device that is configured to receive an input from an operator and, in response to receiving the input, one of: provide a control signal for controlling an output of the motor or create an electrical coupling that provides power to the motor.

Aspect 12: The wheelchair of aspect 11, wherein the frame of the wheelchair is collapsible relative to an axis of rotation of the wheel of the plurality of wheels.

Aspect 13: The wheelchair of aspect 11 or aspect 12, wherein the motor is offset from a plane that is perpendicular to the axis of rotation of the wheel and that bisects the wheelchair.

Aspect 14: The Wheelchair of any one of aspects 11-13, wherein the motor is offset from the plane by at least 6 inches.

Aspect 15: The wheelchair of any one of aspects 11-13, further comprising a clutch that is configured to selectively engage and disengage the motor from the wheel.

Aspect 16: The wheelchair of any one of aspects 11-15, wherein the motor has a power output that is less than 200 watts.

Aspect 17: The wheelchair of any one of aspects 11-16, Wherein the power source is a battery that is releasable by a push button &tent.

Aspect 18: The wheelchair of any one of aspects 11-17, wherein the drive assembly has a total weight of less than 3.0 kg.

Aspect 19: The wheelchair of any one of aspects 11-18, wherein the frame comprises at least one handle, wherein the input device is disposed proximate to the at least one handle.

Aspect 20: The Wheelchair of any one of aspects 11-19, wherein the input device comprises a lever.

Aspect 21: The wheelchair of any one of aspects 11-20, wherein the wheel of the plurality of wheels has a rotational axis, wherein the wheelchair further comprises; a. push rim having a rotational axis that is offset from the rotational axis of the wheel of the plurality of wheels; and a push rim sprocket that is fixedly coupled to the push rim, wherein the belt or chain engages the push rim sprocket.

Aspect 22: The Wheelchair of any one of aspects 11-21, wherein the frame comprises a plurality of frame members and at least one brace connected to at least one of the frame members, wherein the at least one brace is configured to release the at least one of the frame members to collapse the wheelchair relative to a collapsible axis.

Aspect 23: The Wheelchair as in any one of aspects 11-22, Wherein the motor is limited to causing a top speed of the wheelchair of 1.5 meters per second.

Although the foregoing invention has been described in some detail by way of illustration and example for purposes of clarity of understanding, certain changes and modifications may be practiced within the scope of the appended claims.

What is claimed is:

1. A drive assembly for a wheelchair having a frame and a first drive wheel and a second drive wheel that are rotatably coupled to the frame, wherein each of the first drive wheel and second drive wheel is fixedly coupled to a respective axle so rotation of the respective axle causes corresponding rotation of the respective drive wheel, the drive assembly comprising:
a first motor;
a power source that is configured to power the first motor;
a first drive shaft that is coupled to the first motor;
a first transmission that is configured to couple the first drive shaft to the respective axle that is fixedly coupled to the first drive wheel; and
an input device that is configured to receive an input from an operator and, in response to receiving the input, and to perform at least one of the following actions:
provide a control signal for controlling an output of the first motor; or
create an electrical coupling that provides power to the first motor,

2. The drive assembly of claim 1, wherein the first transmission comprises:
a first sprocket that is fixedly coupled to the drive shaft so that rotation of the drive shaft causes corresponding rotation of the first sprocket;
a second sprocket that is configured to be rotationally fixed to the respective axle that is coupled to the first drive wheel; and
a drive belt or chain that extends between the first sprocket and the second sprocket.

3. The drive assembly of claim 1, further comprising:
a second motor that is configured to receive power from the power source;
a second drive shaft that is coupled to the second motor; and
a second transmission that is configured to couple the second drive shaft to the respective axle that is fixedly coupled to the second drive wheel,
wherein, in response to receiving the input, the input device is configured to one of: provide a second control signal for controlling an output of the second motor or create a second electrical coupling that provides power to the second motor.

4. The drive assembly of claim 1, wherein the first motor is a back-drivable motor.

5. The drive assembly as in claim 1, further comprising a clutch that is configured to decouple the first motor from the first axle.

6. The drive assembly as in claim 1, wherein the first motor is positioned on a first side of the wheelchair, wherein the first drive shaft extends from the first motor toward an opposing second side of the wheelchair.

7. A wheelchair comprising:
a frame;
a first drive wheel and a second drive wheel;
a respective axle that is fixedly coupled to each of the first drive wheel and the second drive wheel so rotation of the respective axle causes corresponding rotation of the respective drive wheel, wherein each of the first drive wheel and second drive wheel is rotatably coupled to the frame via the respective axle; and
a drive assembly comprising:
a first motor;
a power source that is configured to power the first motor;
a first drive shaft that is coupled to the first motor;
a first transmission that is configured to couple the first drive shaft to the respective axle that is fixedly coupled to the first drive wheel; and
an input device that is con figured to receive an input from an operator and, in response to receiving the input, to perform at least one of the following actions:
provide a control signal for controlling an output of the first motor; or
create an electrical coupling that provides power to the first motor.

8. The wheelchair of claim 7, wherein the first transmission comprises:
a first sprocket that is fixedly coupled to the first drive shaft so that rotation of the first drive shaft causes corresponding rotation. of the first sprocket;
a second sprocket that is fixedly coupled to the respective axle that is coupled to the first drive Wheel so that rotation of the second sprocket causes corresponding rotation of the respective axle that is coupled to the first drive wheel; and
a drive belt or chain that extends between the first sprocket and the second sprocket.

9. The wheelchair of claim 7, further comprising:
a second motor that is configured to receive power from the power source;
a second drive shaft that is coupled to the second motor; and
a second transmission that is configured to couple the second drive shaft to the respective axle that is fixedly coupled to the second drive wheel,
wherein, in response to receiving the input the input device is configured to one of: provide a second control signal for controlling an output of the second motor or create a second electrical coupling that provides power to the second motor.

10. The wheelchair of claim 7, wherein the first motor is a back-drivable motor.

11. The wheelchair as in claim 7, further comprising a clutch that is configured to decouple the first motor from the first axle.

12. The wheelchair as in claim 7, wherein the first motor is positioned on a first side of the wheelchair, wherein the first drive shaft extends from the first motor toward an opposing second side of the wheelchair.

13. A wheelchair comprising:
a frame;
a plurality of wheels rotatably attached to the frame;
a motor coupled to the frame;
a power source that is configured to power the motor;
a drive shaft that is coupled to the motor;
a first sprocket that is coupled to the drive shaft;
a second sprocket that is rotationally fixed to a wheel of the plurality of wheels;
a drive belt or chain that extends between the first sprocket and the second sprocket; and
an input device that is configured to receive an input from an operator and, in response to receiving the input, to perform at. least. one of the following actions:
provide a control signal for controlling an output of the motor, or
create an electrical. coupling that provides power to the motor.

14. The wheelchair of claim 13, wherein the input device comprises a variable speed throttle.

15. The wheelchair of claim 13, wherein the frame of the wheelchair is collapsible relative to an axis of rotation of the wheel of the plurality of Wheels.

16. The wheelchair of claim 13, wherein the motor is offset from a plane that is perpendicular to the axis of rotation of the wheel and that bisects the wheelchair.

17. The wheelchair of claim 13, wherein the motor is offset from the plane by at least 6 inches.

18. The wheelchair of claim 13, wherein the drive assembly has a total weight of less than 3.0 kg.

19. The wheelchair of claim 13, wherein the frame comprises at least one handle, wherein the input device is disposed proximate to the at least one handle.

20. The wheelchair of claim 13, wherein the wheel of the plurality of wheels has a rotational axis, wherein the wheelchair further comprises:
a push rim having a rotational axis that is offset from the rotational axis of the wheel of the plurality of wheels; and
a push rim sprocket that is fixedly coupled to the push rim,
wherein the belt or chain engages the push rim sprocket.
